(19) United States
(12) Patent Application Publication
(10) Pub. No.: US 2018/0335926 A1
(43) Pub. Date: Nov. 22, 2018

(54) MEDIA RESOURCE SHARING METHOD, AND DEVICE

(71) Applicant: Huawei Technologies Co., Ltd.

(72) Inventors: Yunsheng KUANG, Shenzhen (CN); Zhenwei SHAN, Shenzhen (CN); Yu ZHU, Shenzhen (CN)

(21) Appl. No.: 15/525,022

(22) PCT Filed: Nov. 7, 2014
(86) PCT No.: PCT/CN2014/090597

§ 371 Date: May 5, 2017

(51) Int. Cl. G06F 3/0484; G06K 9/00; G06K 9/46; G06F 3/0488

(52) U.S. Cl. CPC G06F 3/04842; G06K 9/0008; G06K 2009/4666; G06F 3/04883; G06K 9/46

(57) ABSTRACT

A media resource sharing method comprising: determining, by a source device, a media resource selected by a user, generating first verification information according to a user operation, and receiving an identifier of a playing device and second verification information that are sent by the playing device, where the second verification information is sent by the playing device according to a user operation; determining, by the source device according to the first verification information and the second verification information, that the source device and the playing device are successfully paired, and sending, according to the identifier of the playing device, the media resource to the playing device for playing; or sending address information of the media resource to the playing device according to the identifier of the playing device.

### CROSS-REFERENCE TO RELATED APPLICATIONS

This application is a national stage of International Application No. PCT/CN2014/090597, filed on Nov. 7, 2014, which is hereby incorporated by reference in its entirety.

### TECHNICAL FIELD

Embodiments of the present invention relate to the field of communications technologies, and in particular, to a media resource sharing method and a device.

### BACKGROUND

Media sharing is an important application of a mobile electronic device, especially in a home network. Currently, in all commercially available solutions of digital media transmission and sharing, media transmission and sharing are implemented through manual operations of users. First, a source device (source) providing media content and a playing device (sink) receiving and playing the media content need to be connected to a same local area network (LAN) in a wired or wireless manner, to ensure that the two devices can be connected and complete transmission of media data.

Using the Digital Living Network Alliance (DLNA) as an example, it is assumed that a user performs an operation on a playing device, and a media resource shared on a source device is discovered and obtained and is played on the playing device. A specific process is as follows:

The user opens an application program of the DLNA, and taps a button “nearby devices”, to search for a source device located in a same local area network.

A system displays all found nearby source devices to the user, and the user selects a needed device from a nearby devices list. Assuming that two nearby devices are found in total, the user taps to select a source device whose device identifier is “[Mobile]GT-N7000”.

The system presents, to the user, a list of media content shared by the source device “[Mobile]GT-N7000”.

The user selects, from the list of media content, media content that the user intends to play. It is assumed that the user taps to select media content whose media name is “GALAXY_Note_Tutorial”.

The playing device plays the media content whose name is “GALAXY_Note_Tutorial”.

A process of sharing the media content has a relatively large quantity of operation steps. Five operation steps need to be performed till the media content is played, and in four out of the five steps, the user needs to perform manual selection, causing complex operations.

In addition, in the application program for media sharing, a default device identifier in the system is generally a version of a device, a universally unique identifier (UUID) of a device, an Internet Protocol (IP) address of a device or a Media Access Control (MAC) address of a device. These device identifiers are merely a string of digits or characters for the user. Therefore, it is very difficult for the user to understand these device identifiers and match these device identifiers with a physical device entity, making it more difficult for the user to select a device. For a device, the user may set a different name that is easily identifiable. However, the setting process is also relatively complex.

Moreover, the system identifies a device by using a version of the device. If there are two devices having a same version in the local area network, it is very difficult for the user to distinguish the two devices.

To sum up, in the existing media sharing manner, operations are complex and user experience is poor.

### SUMMARY

Embodiments of the present invention provide a media resource sharing method and a device, so as to simplify a process of implementing media sharing.

Specific technical solutions provided in the embodiments of the present invention are as follows:

According to a first aspect, a media resource sharing method is provided, including:

determining, by a source device, a media resource selected by a user, generating first verification information according to a user operation, and receiving an identifier of a playing device and second verification information that are sent by the playing device; and

determining, by the source device according to the first verification information and the second verification information, that the source device and the playing device are successfully paired, and sending, according to the identifier of the playing device, the media resource to the playing device for playing; or sending address information of the media resource to the playing device according to the identifier of the playing device, so that the playing device obtains the media resource according to the address information of the media resource and plays the media resource.

In this embodiment, a source device generates first verification information according to a user operation, a playing device generates second verification information according to a user operation, the source device compares the second verification information sent by the playing device with the first verification information generated by the source device, and after determining that the source device matches the playing device, the source device sends a to-be-shared media resource or address information of a media resource to the playing device. A user needs to perform only one operation on the playing device and only one operation on the source device to complete a process of sharing the media resource, where the playing device and the source device share the media resource, thereby reducing a quantity of user operations in the media resource sharing process, and reducing difficulty in a media resource sharing operation.

With reference to the first aspect, in a first possible implementation manner, the determining, by a source device, a media resource selected by a user, generating first verification information according to a user operation, and receiving an identifier of a playing device and second verification information that are sent by the playing device includes:

after the source device determines the media resource selected by the user and generates the first verification information according to the user operation, sending, by the source device, a pairing request message to the playing device, where the pairing request message includes an identifier of the source device, and receiving a pairing response message that is returned by the playing device according to the pairing request message, where the pairing response message carries the second verification information and the identifier of the playing device; or

after the source device receives a pairing notification message sent by the playing device, determining, by the source device, the media resource selected by the user, and generating the first verification information according to the user operation, where the pairing notification message includes the second verification information and the identifier of the playing device; or

after the source device determines the media resource selected by the user and generates the first verification information according to the user operation, receiving, by the source device, a pairing notification message sent by the playing device, where the pairing notification message includes the second verification information and the identifier of the playing device.

With reference to the first possible implementation manner of the first aspect, in a second possible implementation manner, after sending the pairing request message to the playing device, the source device receives, within specified duration, the pairing response message that is returned by the playing device according to the pairing request message; or

after receiving the pairing notification message sent by the playing device, the source device determines, within specified duration, the media resource selected by the user, and generates the first verification information according to the user operation; or

after determining the media resource selected by the user and generating the first verification information according to the user operation, the source device receives, within specified duration, the pairing notification message sent by the playing device.

With reference to the first possible implementation manner of the first aspect, in a third possible implementation manner, after the receiving, by the source device, a pairing notification message sent by the playing device, the method further includes:

displaying, by the source device, a list of shared media resources; and/or

before the generating, by the source device, the first verification information according to the user operation, the method further includes:

determining, by the source device, the currently displayed list of shared media resources.

With reference to any one of the first aspect to the third possible implementation manner, in a fourth possible implementation manner, the generating, by a source device, first verification information according to a user operation includes:

generating, by the source device, the first verification information according to collected voice information input by the user; or

generating, by the source device, the first verification information according to a collected sliding trajectory on a screen; or

generating, by the source device, the first verification information according to a collected touch operation of the user at a first location on a screen; or generating, by the source device, the first verification information according to a collected fingerprint image.

With reference to any one of the first possible implementation manner to the third possible implementation manner of the first aspect, in a fifth possible implementation manner, the generating, by a source device, first verification information according to a user operation includes:

after the source device collects a fingerprint image input by the user, and performs direction field correction on the fingerprint image, extracting, by the source device, a fingerprint local feature point from all sub-areas or an appointed sub-area of the fingerprint image that is obtained after the correction, and generating the first verification information according to the extracted fingerprint local feature point; or

after the source device collects a fingerprint image input by the user, and performs direction field correction on the fingerprint image, extracting, by the source device, a fingerprint local feature point from at least one sub-area of the fingerprint image that is obtained after the correction, generating the first verification information according to the extracted fingerprint local feature point, and adding location information of the at least one sub-area to the pairing request message; or

adding location information of a sub-area of a fingerprint image corresponding to the second verification information generated by the playing device to the pairing notification message, and after the source device collects a fingerprint image input by the user, and performs direction field correction on the collected fingerprint image, extracting, by the source device, a fingerprint local feature point from a sub-area that is determined according to location information of the sub-area of the fingerprint image that is obtained after the correction, and generating the first verification information according to the extracted fingerprint local feature point.

According to a second aspect, a media resource sharing method is provided, including:

generating, by a playing device, second verification information according to a user operation;

sending, by the playing device, the second verification information and an identifier of the playing device to a source device; and

receiving, by the playing device, a media resource that is returned by the source device according to the identifier of the playing device, and playing the media resource, or receiving, by the playing device, address information of a media resource that is returned by the source device according to the identifier of the playing device, acquiring the media resource according to the address information of the media resource, and playing the media resource, where

the media resource or the address information of the media resource is returned by the source device after the source device determines, according to the second verification information and first verification information that is generated by the source device according to a user operation, that the source device and the playing device are successfully paired.

With reference to the second aspect, in a first possible implementation manner, the sending, by the playing device, the second verification information and an identifier of the playing device to a source device includes:

receiving, by the playing device, a pairing request message sent by the source device, where the pairing request message is sent by the source device after the source device determines the media resource and generates the first verification information, and the pairing request message includes an identifier of the source device, and returning a pairing response message to the source device according to the identifier of the source device, where the pairing response message carries the second verification information and the identifier of the playing device; or

sending, by the playing device, a pairing notification message to the source device, where the pairing notification message includes the second verification information and the identifier of the playing device.

With reference to the first possible implementation manner of the second aspect, in a second possible implementation manner, the generating, by a playing device, second verification information according to a user operation includes:

generating, by the playing device, the second verification information according to collected voice information input by the user; or

generating, by the playing device, the second verification information according to a collected sliding trajectory on a screen; or

generating, by the playing device, the second verification information according to a touch operation of the user at a second location on a screen; or

generating, by the playing device, the second verification information according to a collected fingerprint image.

With reference to the first possible implementation manner of the second aspect, in a third possible implementation manner, the generating, by a playing device, second verification information according to a user operation includes:

after the playing device collects a fingerprint image input by the user, and performs direction field correction on the fingerprint image, extracting, by the playing device, a fingerprint local feature point from an appointed sub-area of the fingerprint image that is obtained after the correction, and generating the second verification information according to all or some extracted fingerprint local feature points; or

adding location information of a sub-area of a fingerprint image corresponding to the first verification information generated by the source device to the pairing request message, and after the playing device collects a fingerprint image input by the user, and performs direction field correction on the collected fingerprint image, extracting, by the playing device, a fingerprint local feature point from a sub-area that is determined according to location information of the sub-area of the fingerprint image that is obtained after the correction, and generating the second verification information according to all or some extracted fingerprint local feature points; or

after the playing device collects a fingerprint image input by the user, and performs direction field correction on the fingerprint image, extracting, by the playing device, a fingerprint local feature point from at least one sub-area of the fingerprint image that is obtained after the correction, generating the second verification information according to all or some extracted fingerprint local feature points, and adding location information of the at least one sub-area to the pairing notification message.

According to a third aspect, a media resource sharing method is provided, including:

generating, by a playing device, first verification information according to a user operation, and receiving address information of a media resource selected by a user and second verification information that are sent by a source device, where the second verification information is generated by the source device according to a user operation; and

determining, by the playing device according to the first verification information and the second verification information, that the source device and the playing device are successfully paired, acquiring the media resource according to the address information of the media resource, and playing the media resource.

In this embodiment, a playing device generates first verification information according to a user operation, a source device generates second verification information according to a user operation, the playing device compares the second verification information sent by the source device with the first verification information generated by the playing device, after determining that the source device matches the playing device, the playing device requests a to-be-shared media resource from the source device, and the source device sends a media resource selected by a user to the playing device for playing. The user needs to perform only one operation on the playing device and only one operation on the source device to complete a process of sharing the media resource, where the playing device and the source device share the media resource, thereby reducing a quantity of user operations in the media resource sharing process, and reducing difficulty in a media resource sharing operation.

With reference to the third aspect, in a first possible implementation manner, the generating, by a playing device, first verification information according to a user operation, and receiving address information of a media resource selected by a user and second verification information that are sent by a source device includes:

after the playing device generates the first verification information according to the user operation, sending, by the playing device, a pairing request message to the source device, where the pairing request message carries an identifier of the playing device, and receiving a pairing response message that is returned by the source device according to the pairing request message, where the pairing response message carries the second verification information and the address information of the media resource; or

after the playing device receives a pairing notification message sent by the source device, generating, by the playing device, the first verification information according to the user operation, where the pairing notification message carries the second verification information and the address information of the media resource; or

after the playing device generates the first verification information according to the user operation, receiving, by the playing device, a pairing notification message sent by the source device, where the pairing notification message carries the second verification information and the address information of the media resource.

With reference to the first possible implementation manner of the third aspect, in a second possible implementation manner, after sending the pairing request message to the source device, the playing device receives, within specified duration, the pairing response message that is returned by the source device according to the pairing request message; or

after receiving the pairing notification message sent by the source device, the playing device generates the first verification information within specified duration according to the user operation; or

after generating the first verification information according to the user operation, the playing device receives, within specified duration, the pairing notification message sent by the source device.

With reference to the first possible implementation manner of the third aspect, in a third possible implementation manner, after the receiving, by the playing device, the pairing notification message, the method further includes:

starting, by the playing device, a working mode of acquiring and playing a shared media resource; and/or

before the generating, by a playing device, first verification information according to a user operation, the method further includes:

determining, by the playing device, that the playing device is in the working mode of acquiring and playing a shared media resource.

With reference to any one of the first possible implementation manner to the third possible implementation manner of the third aspect, in a fourth possible implementation manner, the generating, by a playing device, first verification information according to a user operation includes:

generating, by the playing device, the first verification information according to collected voice information input by the user; or

generating, by the playing device, the first verification information according to a collected sliding trajectory on a screen; or

generating, by the playing device, the first verification information according to a collected touch operation of the user at a first location on a screen; or

generating, by the playing device, the first verification information according to a collected fingerprint image.

With reference to any one of the first possible implementation manner to the third possible implementation manner of the third aspect, in a fifth possible implementation manner, the generating, by a playing device, first verification information according to a user operation includes:

after the playing device collects a fingerprint image input by the user, and performs direction field correction on the fingerprint image, extracting, by the playing device, a fingerprint local feature point from all sub-areas or an appointed sub-area of the fingerprint image that is obtained after the correction, and generating the first verification information according to the extracted fingerprint local feature point; or

after the playing device collects a fingerprint image input by the user, and performs direction field correction on the fingerprint image, extracting, by the playing device, a fingerprint local feature point from at least one sub-area of the fingerprint image that is obtained after the correction, generating the first verification information according to the extracted fingerprint local feature point, and adding location information of the at least one sub-area to the pairing request message; or

adding location information of a sub-area of a fingerprint image corresponding to the second verification information generated by the source device to the pairing notification message, and after the playing device collects a fingerprint image input by the user, and performs direction field correction on the collected fingerprint image, extracting, by the playing device, a fingerprint local feature point from a sub-area that is determined according to location information of the sub-area of the fingerprint image that is obtained after the correction, and generating the first verification information according to the extracted fingerprint local feature point.

According to a fourth aspect, a media resource sharing method is provided, including:

generating, by a source device, second verification information according to a user operation, and determining address information of a media resource selected by a user; and

sending, by the source device, the second verification information and the address information of the media resource to a playing device, so that after the playing device determines, according to the second verification information and first verification information that is generated by the playing device according to a user operation, that the playing device and the source device are successfully paired, the playing device obtains the media resource according to the address information of the media resource and plays the media resource.

With reference to the fourth aspect, in a first possible implementation manner, the sending, by the source device, the second verification information and the address information of the media resource to a playing device includes:

receiving, by the source device, a pairing request message that is sent by the playing device after the playing device generates the first verification information, where the pairing request message carries an identifier of the playing device, and returning a pairing response message according to the pairing request message, where the pairing response message carries the second verification information and the address information of the media resource; or

sending, by the source device, a pairing notification message, where the pairing notification message carries the second verification information and the address information of the media resource.

With reference to the fourth aspect, in a second possible implementation manner, the generating, by a source device, second verification information according to a user operation includes:

generating, by the source device, the second verification information according to a collected sliding trajectory on a screen; or

generating, by the source device, the second verification information according to a collected touch operation of the user at a second location on a screen; or

generating, by the source device, the second verification information according to a collected fingerprint image.

With reference to the first possible implementation manner of the fourth aspect, in a third possible implementation manner, the generating, by a source device, second verification information according to a user operation includes:

after the source device collects a fingerprint image input by the user, and performs direction field correction on the fingerprint image, extracting, by the source device, a fingerprint local feature point from an appointed sub-area of the fingerprint image that is obtained after the correction, and generating the second verification information according to all or some extracted fingerprint local feature points; or

adding location information of a sub-area of a fingerprint image corresponding to the first verification information generated by the playing device to the pairing request message, and after the source device collects a fingerprint image input by the user, and performs direction field correction on the collected fingerprint image, extracting, by the source device, a fingerprint local feature point from a sub-area that is determined according to location information of the sub-area of the fingerprint image that is obtained after the correction, and generating the second verification information according to all or some extracted fingerprint local feature points; or

after the source device collects a fingerprint image input by the user, and performs direction field correction on the fingerprint image, extracting, by the source device, a fingerprint local feature point from at least one sub-area of the fingerprint image that is obtained after the correction, generating the second verification information according to all or some extracted fingerprint local feature points, and adding location information of the at least one sub-area to the pairing notification message.

According to a fifth aspect, a source device is provided, including:

a first processing module, configured to: determine a media resource selected by a user, generate first verification information according to a user operation, and receive an identifier of a playing device and second verification information that are sent by the playing device, where the second verification information is generated by the playing device according to a user operation; and

a second processing module, configured to: determine, according to the first verification information and the second verification information, that the source device and the playing device are successfully paired, and send, according to the identifier of the playing device, the media resource to the playing device for playing; or send address information of the media resource to the playing device according to the identifier of the playing device, so that the playing device obtains the media resource according to the address information of the media resource and plays the media resource.

With reference to the fifth aspect, in a first possible implementation manner, the first processing module is specifically configured to:

after determining the media resource selected by the user and generating the first verification information according to the user operation, send a pairing request message to the playing device, where the pairing request message includes an identifier of the source device, and receive a pairing response message that is returned by the playing device according to the pairing request message, where the pairing response message carries the second verification information and the identifier of the playing device; or

after receiving a pairing notification message sent by the playing device, determine the media resource selected by the user, and generate the first verification information according to the user operation, where the pairing notification message includes the second verification information and the identifier of the playing device; or

after determining the media resource selected by the user and generating the first verification information according to the user operation, receive a pairing notification message sent by the playing device, where the pairing notification message includes the second verification information and the identifier of the playing device.

With reference to the first possible implementation manner of the fifth aspect, in a second possible implementation manner, the first processing module is specifically configured to:

after sending the pairing request message to the playing device, receive, within specified duration, the pairing response message that is returned by the playing device according to the pairing request message; or

after receiving the pairing notification message sent by the playing device, determine, within specified duration, the media resource selected by the user, and generate the first verification information according to the user operation; or

after determining the media resource selected by the user and generating the first verification information according to the user operation, receive, within specified duration, the pairing notification message sent by the playing device.

With reference to the first possible implementation manner of the fifth aspect, in a third possible implementation manner, the first processing module is further configured to:

after receiving the pairing notification message sent by the playing device, display a list of shared media resources; and/or

before generating the first verification information according to the user operation, determine the currently displayed list of shared media resources.

With reference to any one of the fifth aspect to the third possible implementation manner, in a fourth possible implementation manner, the first processing module is specifically configured to:

generate the first verification information according to collected voice information input by the user; or

generate the first verification information according to a collected sliding trajectory on a screen; or

generate the first verification information according to a collected touch operation of the user at a first location on a screen; or

generate the first verification information according to a collected fingerprint image.

With reference to any one to the first possible implementation manner to the third possible implementation manner of the fifth aspect, in a fifth possible implementation manner, the first processing module is specifically configured to:

after collecting a fingerprint image input by the user, and performing direction field correction on the fingerprint image, extract a fingerprint local feature point from all sub-areas or an appointed sub-area of the fingerprint image that is obtained after the correction, and generate the first verification information according to the extracted fingerprint local feature point; or

after collecting a fingerprint image input by the user, and performing direction field correction on the fingerprint image, extract a fingerprint local feature point from at least one sub-area of the fingerprint image that is obtained after the correction, generate the first verification information according to the extracted fingerprint local feature point, and add location information of the at least one sub-area to the pairing request message; or

add location information of a sub-area of a fingerprint image corresponding to the second verification information generated by the playing device to the pairing notification message, and after collecting a fingerprint image input by the user, and performing direction field correction on the collected fingerprint image, extract a fingerprint local feature point from a sub-area that is determined according to location information of the sub-area of the fingerprint image that is obtained after the correction, and generate the first verification information according to the extracted fingerprint local feature point.

According to a sixth aspect, a playing device is provided, including:

a generation module, configured to generate second verification information according to a user operation;

a sending module, configured to send the second verification information and an identifier of the playing device to a source device; and

a receiving module, configured to receive a media resource that is returned by the source device according to the identifier of the playing device; or receive address information of a media resource that is returned by the source device according to the identifier of the playing device, and obtain the media resource according to the address information of the media resource, where the media resource or the address information of the media resource is returned by the source device after the source device determines, according to the second verification information and first verification information that is generated by the source device according to a user operation, that the source device and the playing device are successfully paired; and

a playing module, configured to play the media resource.

With reference to the sixth aspect, in a first possible implementation manner, the receiving module is further configured to receive a pairing request message sent by the source device, where the pairing request message is sent by the source device after the source device determines the media resource and generates the first verification information, and the pairing request message includes an identifier of the source device; and the sending module is specifically configured to return a pairing response message to the source device according to the identifier of the source device, where the pairing response message carries the second verification information and the identifier of the playing device; or

the sending module is specifically configured to send a pairing notification message, where the pairing notification message includes the second verification information and the identifier of the playing device.

With reference to the first possible implementation manner of the sixth aspect, in a second possible implementation manner, the generation module is specifically configured to:

generate the second verification information according to collected voice information input by the user; or

generate the second verification information according to a collected sliding trajectory on a screen; or

generate the second verification information according to a touch operation of the user at a second location on a screen; or

generate the second verification information according to a collected fingerprint image.

With reference to the first possible implementation manner of the sixth aspect, in a third possible implementation manner, the generation module is specifically configured to:

after collecting a fingerprint image input by the user, and performing direction field correction on the fingerprint image, extract a fingerprint local feature point from an appointed sub-area of the fingerprint image that is obtained after the correction, and generate the second verification information according to all or some extracted fingerprint local feature points; or

add location information of a sub-area of a fingerprint image corresponding to the first verification information generated by the source device to the pairing request message, and after collecting a fingerprint image input by the user, and performing direction field correction on the collected fingerprint image, extract a fingerprint local feature point from a sub-area that is determined according to location information of the sub-area of the fingerprint image that is obtained after the correction, and generate the second verification information according to all or some extracted fingerprint local feature points; or

after collecting a fingerprint image input by the user, and performing direction field correction on the fingerprint image, extract a fingerprint local feature point from at least one sub-area of the fingerprint image that is obtained after the correction, and generate the second verification information according to all or some extracted fingerprint local feature points; and the sending module is further configured to add location information of the at least one sub-area to the pairing notification message.

According to a seventh aspect, a playing device is provided, including:

a first processing module, configured to: generate first verification information according to a user operation, and receive address information of a media resource selected by a user and second verification information that are sent by a source device, where the second verification information is generated by the source device according to a user operation; and

a second processing module, configured to: determine, according to the first verification information and the second verification information, that the source device and the playing device are successfully paired, obtain the media resource according to the address information of the media resource, and play the media resource.

With reference to the seventh aspect, in a first possible implementation manner, the first processing module is specifically configured to:

after generating the first verification information according to the user operation, send a pairing request message to the source device, where the pairing request message carries an identifier of the playing device, and receive a pairing response message that is returned by the source device according to the pairing request message, where the pairing response message carries the second verification information and the address information of the media resource; or

after receiving a pairing notification message sent by the source device, generate the first verification information according to the user operation, where the pairing notification message carries the second verification information and the address information of the media resource; or

after generating the first verification information according to the user operation, receive a pairing notification message sent by the source device, where the pairing notification message carries the second verification information and the address information of the media resource.

With reference to the first possible implementation manner of the seventh aspect, in a second possible implementation manner, the first processing module is specifically configured to:

after sending the pairing request message to the source device, receive, within specified duration, the pairing response message that is returned by the source device according to the pairing request message; or

after receiving the pairing notification message sent by the source device, generate the first verification information within specified duration according to the user operation; or

after generating the first verification information according to the user operation, receive, within specified duration, the pairing notification message sent by the source device.

With reference to the first possible implementation manner of the seventh aspect, in a third possible implementation manner, the first processing module is further configured to:

after receiving the pairing notification message, start a working mode of acquiring and playing a shared media resource; and/or

before generating the first verification information according to the user operation, determine that the playing device is in the working mode of acquiring and playing a shared media resource.

With reference to any one of the seventh aspect to the third possible implementation manner, in a fourth possible implementation manner, the first processing module is specifically configured to:

generate the first verification information according to collected voice information input by the user; or

generate the first verification information according to a collected sliding trajectory on a screen; or

generate the first verification information according to a collected touch operation of the user at a first location on a screen; or

generate the first verification information according to a collected fingerprint image.

With reference to any one of the seventh aspect to the third possible implementation manner, in a fifth possible implementation manner, the first processing module is specifically configured to:

after collecting a fingerprint image input by the user, and performing direction field correction on the fingerprint image, extract a fingerprint local feature point from all sub-areas or an appointed sub-area of the fingerprint image that is obtained after the correction, and generate the first verification information according to the extracted fingerprint local feature point; or

after collecting a fingerprint image input by the user, and performing direction field correction on the fingerprint image, extract a fingerprint local feature point from at least one sub-area of the fingerprint image that is obtained after the correction, generate the first verification information according to the extracted fingerprint local feature point, and add location information of the at least one sub-area to the pairing request message; or

add location information of a sub-area of a fingerprint image corresponding to the second verification information generated by the source device to the pairing notification message, and after collecting a fingerprint image input by the user, and performing direction field correction on the collected fingerprint image, extract a fingerprint local feature point from a sub-area that is determined according to location information of the sub-area of the fingerprint image that is obtained after the correction, and generate the first verification information according to the extracted fingerprint local feature point.

According to an eighth aspect, a source device is provided, including:

a processing module, configured to: generate second verification information according to a user operation, and determine address information of a media resource selected by a user; and

a sending module, configured to send the second verification information and the address information of the media resource to a playing device, so that after the playing device determines, according to the second verification information and first verification information that is generated by the playing device according to a user operation, that the playing device and the source device are successfully paired, the playing device obtains the media resource according to the address information of the media resource and plays the media resource.

With reference to the eighth aspect, in a first possible implementation manner, the source device further includes a receiving module, configured to receive a pairing request message that is sent by the playing device after the playing device generates the first verification information, where the pairing request message carries an identifier of the playing device; and the sending module is specifically configured to return a pairing response message according to the pairing request message, where the pairing response message carries the second verification information and the address information of the media resource; or

the sending module is specifically configured to send a pairing notification message, where the pairing notification message carries the second verification information and the address information of the media resource.

With reference to the first possible implementation manner of the eighth aspect, in a second possible implementation manner, the processing module is specifically configured to:

generate the second verification information according to a collected sliding trajectory on a screen; or

generate the second verification information according to a touch operation of the user at a second location on a screen; or

generate the second verification information according to a collected fingerprint image.

With reference to the first possible implementation manner of the eighth aspect, in a third possible implementation manner, the processing module is specifically configured to:

after collecting a fingerprint image input by the user, and performing direction field correction on the fingerprint image, extract a fingerprint local feature point from an appointed sub-area of the fingerprint image that is obtained after the correction, and generate the second verification information according to all or some extracted fingerprint local feature points; or

add location information of a sub-area of a fingerprint image corresponding to the first verification information generated by the playing device to the pairing request message, and after collecting a fingerprint image input by the user, and performing direction field correction on the collected fingerprint image, extract a fingerprint local feature point from a sub-area that is determined according to location information of the sub-area of the fingerprint image that is obtained after the correction, and generate the second verification information according to all or some extracted fingerprint local feature points; or

after collecting a fingerprint image input by the user, and performing direction field correction on the fingerprint image, extract a fingerprint local feature point from at least one sub-area of the fingerprint image that is obtained after the correction, generate the second verification information according to all or some extracted fingerprint local feature points, and add location information of the at least one sub-area to the pairing notification message.

### BRIEF DESCRIPTION OF DRAWINGS

FIG. 1 is a schematic flowchart of a media resource sharing method according to an embodiment of the present invention;

FIG. 2 is a schematic diagram of a detailed process of media resource sharing according to an embodiment of the present invention;

FIG. 3 is a schematic flowchart of a process of generating second verification information according to an embodiment of the present invention;

FIG. 4 is a schematic diagram of an example of second verification information according to an embodiment of the present invention;

FIG. 5 is a schematic diagram of another detailed process of media resource sharing according to an embodiment of the present invention;

FIG. 6 is a schematic flowchart of another media resource sharing method according to an embodiment of the present invention;

FIG. 7 is a schematic structural diagram of a source device according to an embodiment of the present invention;

FIG. 8 is another schematic structural diagram of a source device according to an embodiment of the present invention;

FIG. 9 is a schematic structural diagram of a playing device according to an embodiment of the present invention;

FIG. 10 is another schematic structural diagram of a playing device according to an embodiment of the present invention;

FIG. 11 is another schematic structural diagram of a playing device according to an embodiment of the present invention;

FIG. 12 is another schematic structural diagram of a playing device according to an embodiment of the present invention;

FIG. 13 is another schematic structural diagram of a source device according to an embodiment of the present invention; and

FIG. 14 is another schematic structural diagram of a source device according to an embodiment of the present invention.

### DESCRIPTION OF EMBODIMENTS

To make the objectives, technical solutions, and advantages of the present invention clearer, the following further describes the present invention in detail with reference to the accompanying drawings. Apparently, the described embodiments are merely a part rather than all of the embodiments of the present invention. All other embodiments obtained by a person of ordinary skill in the art based on the embodiments of the present invention without creative efforts shall fall within the protection scope of the present invention.

In the embodiments of the present invention, according to functional division, a local area network includes at least one source device and includes at least one playing device. In a specific implementation, both a function of a source device and a function of a playing device may be integrated into a physical device in the local area network.

The source device is a provider of media content in an application scenario of media sharing. Generally, a home network device having a network connection function or a storage function, such as a smartphone, a tablet computer, a set top box, a web disk, or a personal digital assistant (PDA), may be used as a source device.

The source device may share a locally stored media resource, or may provide address information of a media resource stored on a network side or in another device, so that a playing device obtains corresponding media content from the network side or the another device according the provided address information and plays the corresponding media content. Alternatively, the source device may encode a screen picture of the source device as a media stream, and transmit the media stream to a playing device, to implement one-screen sharing.

When the source device shares media content, the source device needs to provide a content list of to-be-shared media content, so that a user selects media content to be played.

The playing device is a receiver of the media content in the application scenario of media sharing, and can play selected shared media content. Generally, a home network device having a network connection function and a playing capability, such as a smartphone, a tablet computer, a television, a stereo, or a digital versatile disc (DVD) player, may be used as a source device.

The playing device can discover a source device that is connected to a same local area network as the playing device is, and can obtain to-be-played media content from the source device or according to media address information provided by the source device, and play the media content locally.

A conventional application scenario of an implementation of the present invention is a home network. There are multiple types of mobile electronic devices in a home network environment. These mobile electronic devices all can be connected to the home network. Some mobile electronic devices have a storage function, can store a particular quantity of media files and share the media files on the home network, and can be used as source devices. Some mobile electronic devices have a media playing capability, can play media content such as music or a movie, and can be used as playing devices.

Another conventional application scenario is sharing between friends. For example, a person visits a friend's home, and intends to share to-be-shared media content on the home network of the friend's home; or several friends all access a same wireless local area network (WLAN) outside to share media content with each other. Such a case belongs to a temporarily established media sharing network, and a convenient and fast device selection manner conforming to a user operating habit is required.

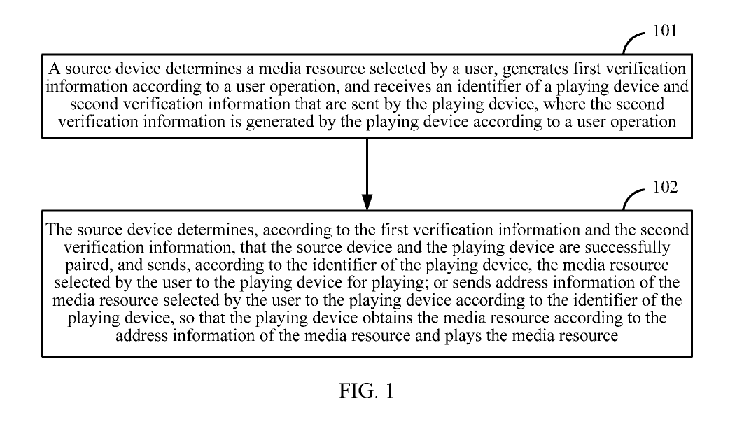

In a first embodiment of the present invention, as shown in FIG. 1, a procedure of a detailed method for sharing a media resource between a source device and a playing device that are located in a same local area network is as follows:

Step 101. The source device determines a media resource selected by a user, generates first verification information according to a user operation, and receives second verification information sent by the playing device and an identifier of the playing device, where the second verification information is generated by the playing device according to a user operation.

Step 102. The source device determines, according to the first verification information and the second verification information, that the source device and the playing device are successfully paired, and sends, according to the identifier of the playing device, the media resource selected by the user to the playing device for playing; or sends address information of the media resource selected by the user to the playing device according to the identifier of the playing device, so that the playing device obtains the media resource according to the address information of the media resource and plays the media resource.

The source device and the playing device are connected to a same local area network, and the source device and the playing device discover each other.

In this embodiment of the present invention, for the generating, by the source device, first verification information, and receiving second verification information of the playing device and an identifier of the playing device, there may be specifically the following three different specific implementation manners:

In a first implementation manner, after determining the media resource selected by the user and generating the first verification information according to the user operation, the source device sends a pairing request message to the playing device in the local area network, where the pairing request message includes an identifier of the source device; and receives a pairing response message that is returned by the playing device in the local area network according to the pairing request message, where the pairing response message carries the second verification information and the identifier of the playing device.

Preferably, in the first specific implementation manner, after sending the pairing request message to the playing device in the local area network, the source device receives, within specified duration, the pairing response message that is returned by the playing device in the local area network according to the pairing request message. A pairing response message that is received by the source device beyond the specified duration is invalid. For example, the specified duration may be set to one minute, two minutes, or the like.

In a second implementation manner, after receiving a pairing notification message sent by the playing device in the local area network, the source device determines the media resource selected by the user, and generates the first verification information according to the user operation, where the pairing notification message includes the second verification information and the identifier of the playing device.

Preferably, in the second specific implementation manner, after receiving the pairing notification message sent by the playing device in the local area network, the source device determines, within specified duration, the media resource selected by the user, and generates the first verification information according to the user operation. If within the specified duration, the source device does not determine the media resource selected by the user and does not generate the first verification information according to the user operation, the pairing notification message received by the source device is invalid. For example, the specified duration may be set to one minute, two minutes, or the like.

In a third implementation manner, after determining the media resource selected by the user and generating the first verification information according to the user operation, the source device receives a pairing notification message sent by the playing device in the local area network, where the pairing notification message includes the second verification information and the identifier of the playing device.

Preferably, in the third specific implementation manner, after determining the media resource selected by the user and generating the first verification information according to the user operation, the source device receives, within specified duration, the pairing notification message sent by the playing device in the local area network. A pairing notification message that is received by the source device beyond the specified duration is invalid. For example, the specified duration may be set to one minute, two minutes, or the like.

Preferably, after the playing device receives the pairing request message, the playing device starts a working mode of acquiring and playing a shared media resource; and/or

before the playing device generates the second verification information according to the user operation, the playing device determines that the playing device is in the working mode of acquiring and playing a shared media resource.

Preferably, after receiving the pairing notification message sent by the playing device in the local area network, the source device displays a list of shared media resources; and/or

before generating the first verification information according to the user operation, the source device determines the currently displayed list of shared media resources.

In this embodiment of the present invention, the first verification information and the second verification information may be generated in multiple manners, which include, but are not limited to, the following manners.

In a first manner, the first verification information is generated by the source device according to collected voice information input by the user, and the second verification information is generated by the playing device according to collected voice information input by the user. Specifically, the source device collects a speech signal sent by the user, extracts voiceprint feature data from the speech signal, and uses the extracted voiceprint feature data as the first verification information. Similarly, the playing device collects a speech signal sent by the user, extracts voiceprint feature data from the speech signal, and uses the extracted voiceprint feature data as the second verification information.

In a second manner, the first verification information is generated by the source device according to a collected sliding trajectory on a screen, and the second verification information is generated by the playing device according to a collected sliding trajectory on a screen. Preferably, the sliding trajectory includes a formed pattern (for example, a circle, a rectangle, a triangle, a heart shape, or another irregular pattern) and a sliding vector (for example, a leftward, rightward, upward, downward, clockwise or counterclockwise sliding vector), but does not include a start position and an end position of the sliding trajectory on a device screen.

In a third manner, the first verification information is generated by the source device according to a collected touch operation of the user at a first location on a screen, and the second verification information is generated by the playing device according to a touch operation of the user at a second location on a screen. In a specific implementation, the touch operation may be a tap operation, a long press operation, a slide operation, or the like.

In a fourth manner, the first verification information is generated by the source device according to a collected fingerprint image, and the second verification information is generated by the playing device according to a collected fingerprint image.

Preferably, if the first verification information and the second verification information are generated by collecting fingerprint images of the user, the generating, by a source device, first verification information according to a user operation includes, but is not limited to, the following implementation manners.

In a first implementation manner, after collecting a fingerprint image input by the user, and performing direction field correction on the fingerprint image, the source device extracts a fingerprint local feature point from all sub-areas or an appointed sub-area of the fingerprint image that is obtained after the correction, and generates the first verification information according to the extracted fingerprint local feature point.

In a second implementation manner, after collecting a fingerprint image input by the user, and performing direction field correction on the fingerprint image, the source device extracts a fingerprint local feature point from at least one sub-area of the fingerprint image that is obtained after the correction, generates the first verification information according to the extracted fingerprint local feature point, and adds location information of the at least one sub-area to the pairing request message.

In a third implementation manner, the source device adds location information of a sub-area of a fingerprint image corresponding to the second verification information generated by the playing device to the pairing notification message, and after collecting a fingerprint image input by the user, and performing direction field correction on the collected fingerprint image, and after receiving the pairing notification message sent by the playing device, the source device extracts a fingerprint local feature point from a sub-area that is determined according to location information, carried in the pairing notification message, of the sub-area of the fingerprint image that is obtained after the correction, and generates the first verification information according to the extracted fingerprint local feature point.

Correspondingly, the generating, by a playing device, second verification information according to a user operation includes, but is not limited to, the following implementation manners:

In a first implementation manner, corresponding to the first manner of generating the first verification information, after collecting a fingerprint image input by the user, and performing direction field correction on the fingerprint image, the playing device extracts a fingerprint local feature point from an appointed sub-area of the fingerprint image that is obtained after the correction, and generates the second verification information according to all or some extracted fingerprint local feature points.

In a second implementation manner, corresponding to the second manner of generating the first verification information, the pairing request message carries location information of a sub-area of a fingerprint image corresponding to the first verification information generated by the source device, and after collecting a fingerprint image input by the user, and performing direction field correction on the collected fingerprint image, the playing device extracts a fingerprint local feature point from a sub-area that is determined according to location information of the sub-area of the fingerprint image that is obtained after the correction, and generates the second verification information according to all or some extracted fingerprint local feature points.

In a third implementation manner, corresponding to the third manner of generating the first verification information, after collecting a fingerprint image input by the user, and performing direction field correction on the fingerprint image, the playing device extracts a fingerprint local feature point from at least one sub-area of the fingerprint image that is obtained after the correction, generates the second verification information according to all or some extracted fingerprint local feature points, and adds location information of the at least one sub-area to the pairing notification message.

In the preferential implementation manner, the second verification information can implement a function of matching and identification. That is, it can be identified, by comparing the first verification information with the second verification information, whether separately collected fingerprints are from a same finger of a same user. In addition, the second verification information does not carry any identity information related to a user fingerprint. Even if a third party obtains the second verification information of the user, the third party cannot verify a user identity by using the second verification information. Moreover, the third party cannot obtain all fingerprint feature information of a user by acquiring second verification information of the user multiple times.

In this embodiment of the present invention, the source device compares the first verification information with the second verification information. If the source device determines that the first verification information is the same as the second verification information, or the second verification information is included in the first verification information, or a similarity between the second verification information and the first verification information reaches a specified threshold, or a ratio of features included in both the second verification information and the first verification information to all features of the second verification information exceeds a specified threshold, the source device determines that the first verification information matches the second verification information.

For example, the sliding trajectory collected by the source device is a triangle, and the first verification information is a triangle. If the sliding trajectory collected by the playing device is also a triangle, that is, the second verification information is a triangle, it is determined that the source device matches the playing device.

For another example, the source device collects first voice information, the first verification information is the first voice information, and the second verification information collected by the playing device is second voice information. If a similarity between the first voice information and the second voice information is greater than a specified threshold, it is determined that the source device matches the playing device. Specifically, matching may be: content of the identified voice information matches, or may be: timbres in the identified voice information match, or the like.

For another example, the source device collects a triple-tap operation of the user at the first location, the first verification information is a triple-tap operation, the playing device collects a triple-tap operation of the user at the second location, and the second verification information is also a triple-tap operation. It may be determined that the first verification information matches the second verification information.

Preferably, the source device compares the second verification information with the first verification information, and if the source device determines that each fingerprint local feature point in the second verification information has a corresponding fingerprint local feature point in the first verification information, the source device determines that the source device and the playing device are successfully paired; or

if the source device determines that a ratio of a quantity of fingerprint local feature points in the second verification information that have corresponding fingerprint local feature points in the first verification information to a total quantity of fingerprint local feature points in the second verification information exceeds a specified threshold, the source device determines that the source device and the playing device are successfully paired.

In this embodiment of the present invention, the identifier of the playing device may be any identifier information that can uniquely determine an identity of the playing device, for example, a digital sequence or a character string, such as a UUID, a device sequence number, an IP address, or a MAC address of the playing device, that can represent the identity of the device.

Similarly, the identifier of the source device may be any identifier information that can uniquely determine an identity of the source device, for example, a digital sequence or a character string, such as a UUID, a device sequence number, an IP address, or a MAC address of the source device, that can represent the identity of the device.

In this embodiment of the present invention, if the source device locally stores content of a media resource selected by a user, the source device directly sends the media resource selected by the user to the playing device for playing. If the source device does not locally store content of a media resource selected by a user, the source device sends address information of the media resource selected by the user to the playing device, so that the playing device obtains the media resource from a network or another storage device according to the address information, and plays the media resource.

In the first embodiment of the present invention, a source device generates first verification information according to a user operation, a playing device generates second verification information according to a user operation, the source device compares the second verification information sent by the playing device with the first verification information generated by the source device, and after determining that the source device matches the playing device, the source device sends a to-be-shared media resource or address information of a media resource to the playing device. A user needs to perform only one operation on the playing device and only one operation on the source device to complete a process of sharing the media resource, where the playing device and the source device share the media resource, thereby reducing a quantity of user operations in the media resource sharing process, and reducing difficulty in a media resource sharing operation.

The following describes, by using two specific embodiments, a specific process in which after verifying that a source device matches a playing device, the source device sends a to-be-shared media resource to the playing device for playing in the first embodiment of the present invention.

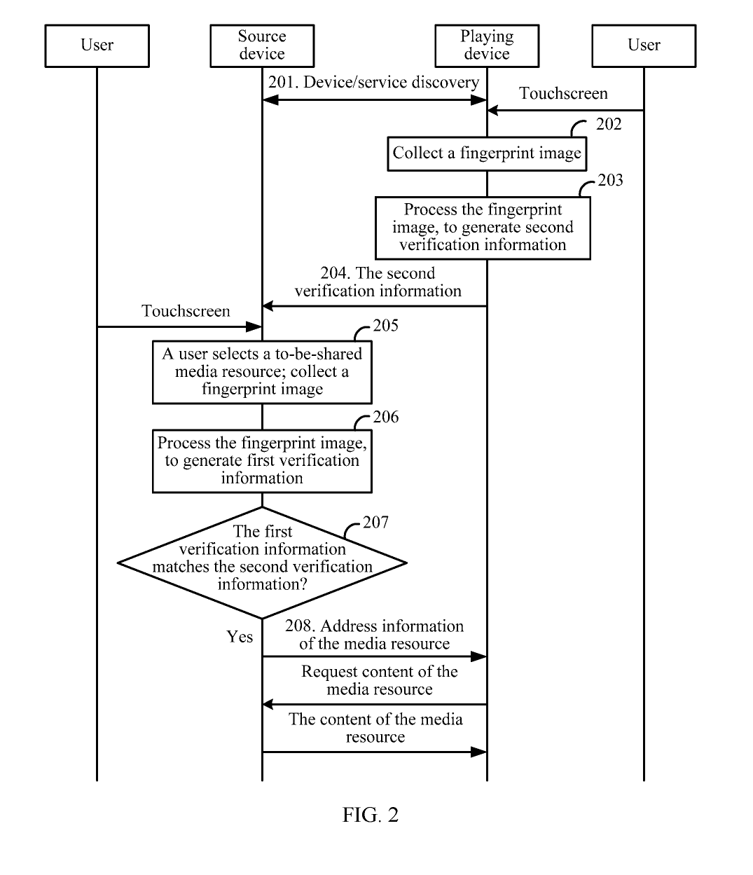

In a first specific embodiment, as shown in FIG. 2, a detailed process of sharing a media resource is as follows:

Step 201: A source device and a playing device discover each other.

In a solution, for example, DLNA, Airplay, Miracast, or Airdrop, of sharing a media resource of a home network, mutual discovery between a source device and a playing device and establishment of a connection are involved, which is the first step for completing media resource sharing. Device and service discovery mechanisms are different in different solutions. For example, a DLNA device uses the Simple Service Discovery Protocol (SSDP) protocol for implementation. However, an Airplay device uses the Multicast Domain Name System (\MDNS) Protocol for implementation. Some other solutions of media sharing use self-developed private devices and service discovery mechanisms for implementation.

When the source device or the playing device is connected to a home network or another type of local area network, the source device or the playing device periodically sends a multicast message to the entire local area network by using a multicast address and port that are stipulated in a protocol or appointed in advance. The multicast message carries device and service discovery information of the sending device, including device information such as a version of a device, an Internet Protocol (IP) address of a device, a device type (source device or playing device), and a UUID of a device, and service information such as an identifier of a service supported by the device, and a Universal Resource Locator (URL) of service access.

Other mobile electronic devices connected to the same local area network all receive the multicast message, thereby acquiring device and service discovery information of a mobile electronic device that sends the multicast message, and the mobile electronic device that sends the multicast message is discovered by the other mobile electronic devices.

Step 202: The playing device collects a fingerprint image that is input by a user by touching a screen or a fingerprint collection area of the playing device.

In the specific implementation manner, a mobile electronic device corresponding to the playing device is a device having a fingerprint collection function. A fingerprint collection manner is determined by a specific function configuration of a mobile electronic device. For some mobile electronic devices, full-screen fingerprint collection can be implemented, that is, each of the mobile electronic devices can collect a fingerprint image when a user taps any area of a touchscreen. For some mobile electronic devices, fingerprint collection on some areas of a screen can be implemented, that is, a mobile electronic device collects a fingerprint image when a user taps some areas of a touchscreen. For some mobile electronic devices, a fingerprint image that remains can be collected only when a user taps or touches a fixed area (for example, a Home button).

When the user taps or touches the screen or touches the fingerprint collection area of the playing device, a fingerprint collector on the playing device can collect a fingerprint of the user in an optical manner, a thermosensitive manner, a biological radio frequency manner, or another manner.

Step 203: The playing device processes the collected fingerprint image, to generate second verification information.

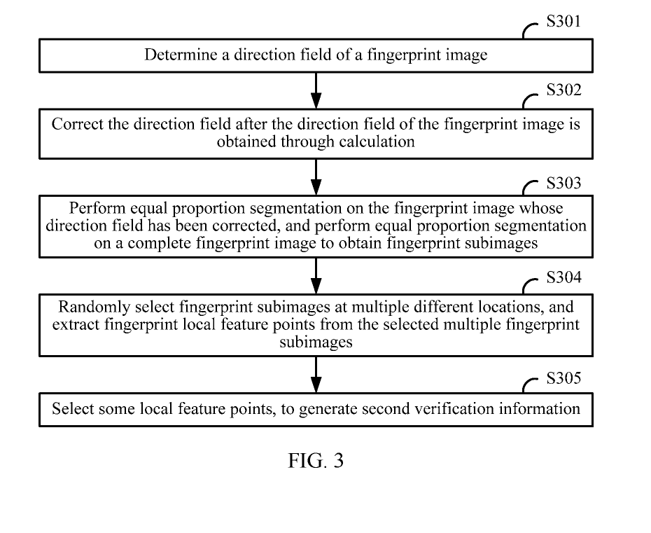

Specifically, as shown in FIG. 3, a process of generating second verification information is as follows:

S301: Determine a direction field of a fingerprint image.

In this embodiment of the present invention, when a fingerprint collection apparatus on the playing device collects a fingerprint image, a pressing direction of a finger of the user is not limited. The user may press, with a finger, the screen or another specified fingerprint collection area in any direction, to input a fingerprint image.

The fingerprint image collected by the playing device includes a central pattern, ridge lines, and valley lines. These line textures have particular tendencies and shapes, and directivity shown by these line textures is the direction field of the fingerprint image. A direction field of a fingerprint is a description of a topological structure of pattern line shapes, representing tendencies and directions of fingerprint pattern lines. The direction field of the fingerprint image may be obtained through calculation by using a masking method and a formula method.

S302: Correct the direction field of the fingerprint image after calculating the direction field.

Specifically, the fingerprint image is rotated, so that a direction of a direction field of the rotated fingerprint image is parallel to a direction of a preset axis, so as to ensure that direction fields of fingerprint images collected on the playing device and the source device are in a same direction.

S303: Perform equal proportion segmentation on the fingerprint image whose direction field has been corrected, and perform equal proportion segmentation on a complete fingerprint image to obtain fingerprint subimages.

In this embodiment of the present invention, some fingerprint feature information is added to the second verification information, and it is ensured that the second verification information does not carry any user identity information related to a user fingerprint, that is, it is forbidden to add all fingerprint feature information in a fingerprint image to the second verification information.

The fingerprint subimages have a same size.

S304: Randomly select fingerprint subimages at multiple different locations, and extract fingerprint local feature points from the selected multiple fingerprint subimages.

Human fingerprint features include general features and local features. Local feature points include six types: termination point, bifurcation point, branch point, isolated point, loop, and short ridge. A complete fingerprint includes approximately 100 local feature points. Each local feature point is described by using six information dimensions: type, horizontal position, vertical position, direction, curvature, and quality. Feature information of these local feature points stays unchanged throughout a lifetime.

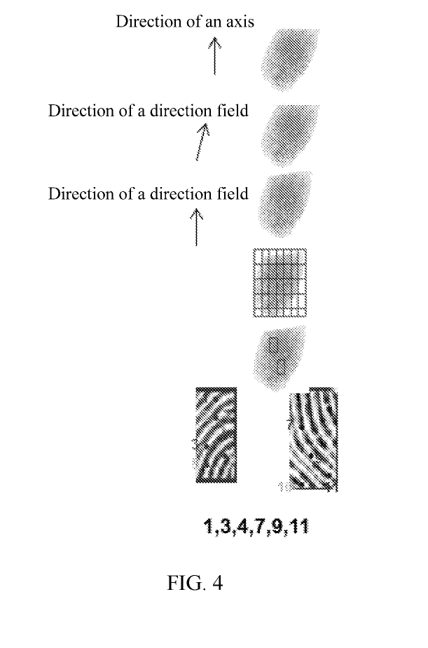

As shown in FIG. 4, a system randomly selects two fingerprint subimages from segmented fingerprint subimages. The one on the left is marked as a fingerprint subimage A, and the one on the right is marked as a fingerprint subimage B. The two fingerprint subimages have a same size (that is, lengths have a same pixel quantity and widths have a same pixel quantity). The fingerprint subimage A includes six fingerprint local feature points, numbered 1 to 6; and the fingerprint subimage B includes five fingerprint local feature points, numbered 7 to 11. After fingerprint local feature points are extracted from the two fingerprint subimages, a feature point list is generated for each fingerprint subimage. Each local feature point in the feature point list includes six pieces of description information of the feature point: a type, a horizontal position, a vertical position, a direction, curvature, and quality. The horizontal position and the vertical position refer to a relative location of the fingerprint local feature point in the fingerprint subimage, instead of an absolute location in the entire fingerprint image.

It should be noted that, when fingerprint subimages are randomly selected, a marginal area of the fingerprint image should not be selected as much as possible, because resolution of the fingerprint image of the area is relatively low, which is adverse to subsequent feature extraction and verification and matching.

S305: Select some local feature points, to generate second verification information.

In step S304, a fingerprint subimage A and a fingerprint subimage B are randomly selected, and six fingerprint local feature points are extracted from the fingerprint subimage A and five fingerprint local feature points are extracted from the fingerprint subimage B. Some fingerprint local feature points are selected from each fingerprint subimage, to form a mixed list of fingerprint local feature points.

In this embodiment of the present invention, six fingerprint local feature points numbered 1, 3, 4, 7, 9, and 11 are separately selected from the fingerprint subimage A and the fingerprint subimage B, to generate second verification information, where fingerprint local feature points 1, 3, and 4 belong to the fingerprint subimage A, and fingerprint local feature points 7, 9, and 11 belong to the fingerprint subimage B. The second verification information includes feature information of some fingerprint local feature points of multiple fingerprint subimages, and these fingerprint subimages are at different locations. Therefore, fingerprint local features provided in the second verification information cannot match a fingerprint local feature of any area in a user fingerprint image. Even if second verification data is obtained by a third party, the third party cannot perform any operation related to user identification and verification by using the second verification information, and the third party also cannot obtain all fingerprint feature information of the user by repeatedly acquiring the second verification information.

Step 204: The playing device sends, in a multicast manner, a multicast event message to all source devices that are connected to a same local area network, where the multicast event message includes not only the second verification information, but also information such as an IP address, a QUID of a device, and an access address URL of the playing device, so that when a source device receives the multicast event message, the source device can determine the playing device that sends the message.

After the playing device generates the second verification information, it means that selection of a playing device in sharing of a media resource is completed. The playing device broadcasts the multicast event message by using a local area network to which the playing device is connected, and all source devices in the network can receive the multicast event message.

Step 205: The user selects a to-be-shared media resource on a source device selected by the user, and when the user selects the media resource, the source device collects a fingerprint image input by the user.

The user selects one source device, and in this case, the source device presents a list of shared media resources. The user taps a touchscreen of the source device, to select a to-be-shared media resource, and completes selection of a media resource. In addition, when the user selects the to-be-shared media resource, the user touches a display and leaves a fingerprint on the display. Therefore, the source device can also collect a fingerprint image of the user.

Step 206: The source device processes the collected fingerprint image, to generate first verification information.

Specifically, the source device determines a direction field of the collected fingerprint image, and corrects the direction field, so that the fingerprint image collected on the source device is parallel to a direction of a preset axis, so as to ensure that direction fields of the fingerprint images collected on the playing device and the source device are in a same direction. The source device scales up/down the fingerprint image that is obtained after the correction, to make the fingerprint image and the fingerprint image collected on the playing device have a same size. The source device extracts, according to fingerprint subimage location and size information, carried in the received second verification information, of extracted local feature points, fingerprint subimages having a same size at a same location of the fingerprint image collected by the source device. The source device extracts fingerprint local feature points from each extracted fingerprint subimage, and gathers feature information of all extracted fingerprint local feature points, to generate the first verification information.

For a specific method for generating the first verification information, refer to descriptions of the foregoing steps S301 to S305.

Step 207: The source device compares the first verification information with the second verification information, to verify whether fingerprints separately collected on the playing device and the source device match.

The second verification information received by the source device includes feature information of some fingerprint local feature points in two fingerprint subimages, second verification information generated by the source device includes feature information of all fingerprint local feature points in fingerprint subimages at locations that are the same as those of the two fingerprint subimages. Comparison is performed on feature information of each fingerprint local feature point in the second verification information, to check whether there is a corresponding fingerprint local feature point in the first verification information. For each fingerprint local feature point, six description dimensions: type, horizontal position, vertical position, direction, curvature, and quality, in fingerprint feature information need to be compared. If feature information is consistent, the fingerprint local feature point has a matching fingerprint local feature point in the first verification information, the matching succeeds; otherwise, comparison on the fingerprint local feature point fails.

For determining whether the second verification information matches the first verification information, a particular threshold is generally set. That is, if a quantity of fingerprint local feature points that are successfully matched in the second verification information or a ratio of a quantity of fingerprint local feature points that are successfully matched to a total quantity of fingerprint local feature points in the second verification information exceeds a threshold, it is determined that the second verification information matches the first verification information, that is, fingerprints collected from the playing device and the source device are fingerprints of a same user; otherwise, it is determined that the second verification information does not match the first verification information.

In the specific embodiment, the second verification information includes six fingerprint local feature points, and the first verification information includes 11 fingerprint local feature points. The six fingerprint local feature points in the first verification information are separately and sequentially compared with feature information of the 11 fingerprint local feature points in the second verification information. If a quantity of fingerprint local feature points that are successfully matched in the second verification information is greater than or equal to a threshold 4, it is determined that the matching succeeds. The threshold is preset according to a specific situation and an actual requirement of a user. A larger specified threshold indicates higher security, a larger amount of computation, and a longer response time. A smaller specified threshold indicates a shorter response time and lower security.

Step 208: If the matching succeeds, the source device directly sends address information of the to-be-shared media resource selected by the user to the playing device, and the playing device obtains media content according to the address information and plays the media content on the playing device.

If the matching succeeds, the source device directly sends a playing request command to the selected playing device, where the playing request command includes the address information (URL) of the to-be-shared media resource selected by the user. After receiving the playing request command, the playing device sends, according to the address information, a request to the source device or to a server that stores content of the media resource. A received corresponding message is a media stream of the content of the media resource, and the playing device can play the content. The user does not need to participate in the entire process.

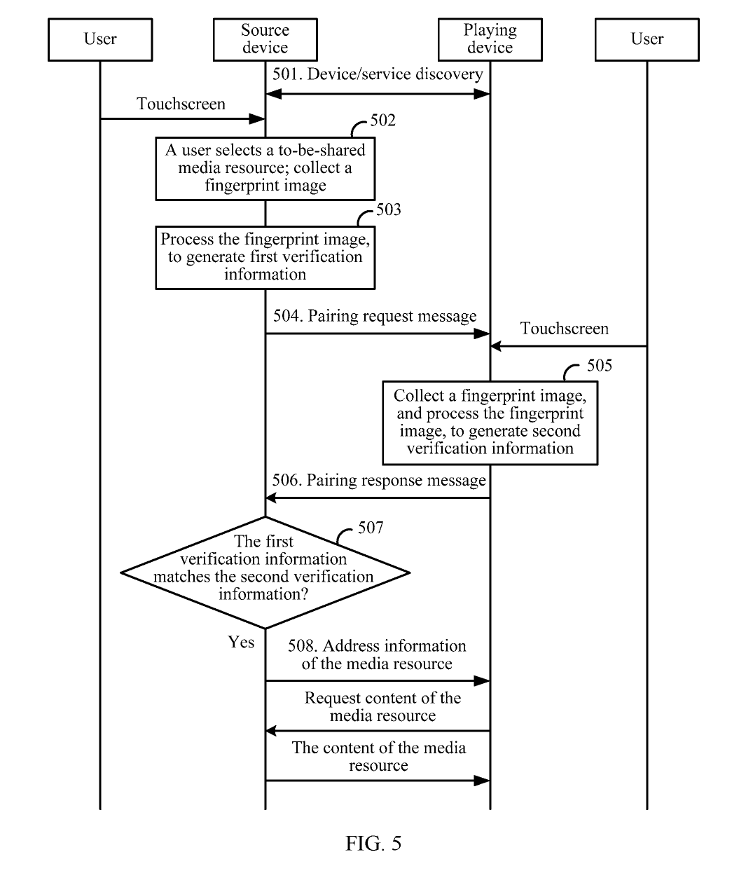

In a second specific embodiment, as shown in FIG. 5, a detailed process of sharing a media resource is as follows:

Step 501: A source device and a playing device discover each other.

For a specific process, refer to the description of step 201 in the first specific embodiment, and the details are not described herein.

Step 502: A user touches a touchscreen of the source device, and selects a to-be-shared media resource; and the source device collects a fingerprint image input by the user when the user touches the touchscreen, and determines the to-be-shared media resource selected by the user.

Step 503: The source device processes the fingerprint image, to generate first verification information.

A specific process is approximately the same as the description of generating first verification information in the first specific embodiment. A difference lies in that: assuming that after direction field correction and equal proportion segmentation are performed on the collected fingerprint image, two fingerprint subimages are randomly selected and are marked as a fingerprint subimage C and a fingerprint subimage D, and fingerprint local feature points are to be extracted from the two fingerprint subimages. Assuming that eight fingerprint local feature points are extracted from the fingerprint subimage C, and six fingerprint local feature points are extracted from the fingerprint subimage D, the generated first verification information includes feature information of all the 14 fingerprint local feature points extracted from the fingerprint subimage C and the fingerprint subimage D.

Step 504: The source device sends a pairing request message to all playing devices in a local area network to which the source device is connected.

The pairing request message carries address information of the source device.

After the source device generates the first verification information, the source device sends a pairing request message to all playing devices that are connected to a same local area network as the source device is, where the pairing request includes a quantity of fingerprint subimages that are randomly selected by the source device and location information of each fingerprint subimage, so that after acquiring a fingerprint image of the user, the playing device can obtain a fingerprint subimage at a same location according to the pairing request message. For the sent pairing request message, the source device sets a waiting time threshold. After the source device sends the pairing request, if the source device does not receive, within a range of the waiting time threshold, a response packet returned by the playing device, the source device automatically considers that the request is invalid, and no pairing relationship is established between the source device and the playing device that corresponds to the pairing request.

Step 505: The user touches a screen on a playing device selected by the user, and the playing device collects a fingerprint image of the user, and processes the fingerprint image, to generate second verification information.

Specifically, the playing device determines a direction field of the collected fingerprint image, and corrects the direction field, so that direction fields of the fingerprint image collected on the source device and the fingerprint image collected on the playing device are in a same direction; and scales up/down the fingerprint image that is obtained after the correction, to make the fingerprint image and the fingerprint image collected on the source device have a same size. Then the playing device extracts, according to quantity, location, and size information of a fingerprint subimage that are carried in the received pairing request message, fingerprint subimages having a same size at a same location of the fingerprint image collected by the playing device. The playing device extracts fingerprint local feature points from each extracted fingerprint subimage, randomly selects some fingerprint local feature points from the fingerprint local feature points in each extracted fingerprint subimage, and gathers feature information of the selected some fingerprint local feature points, to generate the second verification information.

In the specific embodiment, the playing device extracts, according to the quantity, location, and size information of a fingerprint subimage that are carried in the pairing request message, two fingerprint subimages at a corresponding location in the fingerprint image collected by the playing device, marks the two fingerprint subimages as a fingerprint subimage C and a fingerprint subimage D, and extracts 14 fingerprint local feature points from the two fingerprint subimages. Eight fingerprint local feature points are extracted from the fingerprint subimage C, and six fingerprint local feature points are extracted from the fingerprint subimage D. Five feature points are randomly selected from the eight fingerprint local feature points in the fingerprint subimage C, and four feature points are randomly selected from the six fingerprint local feature points from the fingerprint subimage D. Feature information of all the nine selected feature points are gathered, to generate the second verification information.

Step 506: The playing device loads the second verification information to a response packet (that is, a pairing response message) of the pairing request message, and sends the response packet to the source device. The pairing response message further carries address information of the playing device.

Step 507: The source device matches the first verification information with the second verification information, to verify whether fingerprints separately collected on the playing device and the source device are a same fingerprint.

For a specific process, refer to step 207 in the first specific embodiment.

Step 508: If the matching succeeds, the source device directly sends a URL of the to-be-shared media resource selected by the user to the playing device, so that the playing device obtains content of the media resource according to information about the URL and plays the content on the playing device.

For a specific process, refer to step 208 in the first specific embodiment.

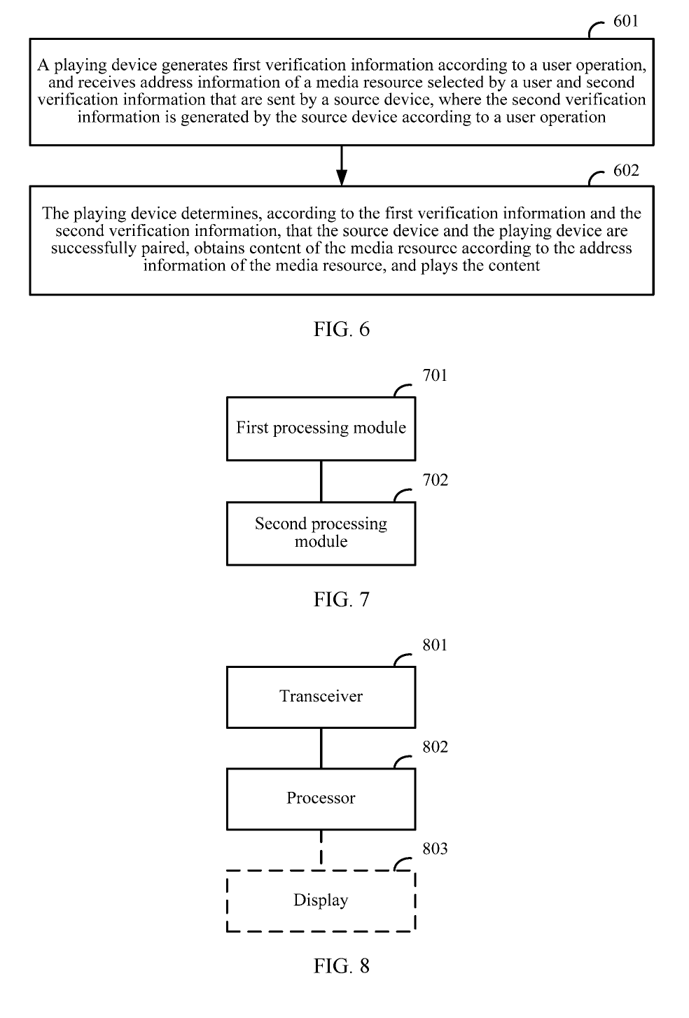

Based on a same inventive concept, in a second embodiment of the present invention, as shown in FIG. 6, a procedure of a detailed media resource sharing method is as follows:

Step 601: A playing device generates first verification information according to a user operation, and receives address information of a media resource selected by a user and second verification information that are sent by a source device, where the second verification information is generated by the source device according to a user operation.

Preferably, for the generating, by a playing device, first verification information according to a user operation, and receiving address information of a media resource selected by a user and second verification information that are sent by a source device, there are specifically the following three specific implementation manners.

In a first implementation manner, after generating the first verification information according to the user operation, the playing device sends a pairing request message to the source device in a local area network, where the pairing request message carries an identifier of the playing device; and receives a pairing response message that is returned by the source device according to the pairing request message, where the pairing response message carries the second verification information and the address information of the media resource.

Preferably, in the first specific implementation manner, after sending the pairing request message to the source device in the local area network, the playing device receives, within specified duration, the pairing response message that is returned by the source device according to the pairing request message. A pairing response message that is received by the playing device beyond the specified duration is invalid. For example, the specified duration may be set to one minute, two minutes, or the like.

In a second implementation manner, after receiving a pairing notification message sent by the source device in a local area network, the playing device generates the first verification information according to the user operation, where the pairing notification message carries the second verification information and the address information of the media resource.

Preferably, in the second specific implementation manner, after receiving the pairing notification message sent by the source device, the playing device generates the first verification information within specified duration according to the user operation. If the playing device does not generate the first verification information within the specified duration according to the user operation, the pairing notification message received by the playing device is invalid. For example, the specified duration may be set to one minute, two minutes, or the like.

In a third implementation manner, after generating the first verification information according to the user operation, the playing device receives a pairing notification message sent by the playing device in a local area network, where the pairing notification message carries the second verification information and the address information of the media resource.

Preferably, in the third specific implementation manner, after generating the first verification information according to the user operation, the playing device receives, within specified duration, the pairing notification message sent by the source device in the local area network. A pairing notification message that is received by the playing device beyond the specified duration is invalid. For example, the specified duration may be set to one minute, two minutes, or the like.

Preferentially, after receiving the pairing notification message, the playing device starts a working mode of acquiring and playing a shared media resource; and/or

before the playing device generates the first verification information according to the user operation, the playing device determines that the playing device is in the working mode of acquiring and playing a shared media resource.

Preferentially, after the source device receives the pairing request message, the source device displays a list of shared media resources; and/or

before the source device generates the second verification information according to the user operation, the source device determines the currently displayed list of shared media resources.

Preferentially, the first verification information and the second verification information are generated in multiple manners, which include, but are not limited to, the following manners.

In a first manner, the first verification information is generated by the playing device according to collected voice information input by the user, and the second verification information is generated by the source device according to collected voice information input by the user. Specifically, the playing device collects a speech signal sent by the user, extracts voiceprint feature data from the speech signal, and uses the extracted voiceprint feature data as the first verification information. Similarly, the source device collects a speech signal sent by the user, extracts voiceprint feature data from the speech signal, and uses the extracted voiceprint feature data as the second verification information.

In a second manner, the first verification information is generated by the playing device according to a collected sliding trajectory on a screen, and the second verification information is generated by the source device according to a collected sliding trajectory on a screen.

Preferably, the sliding trajectory includes a formed pattern (for example, a circle, a rectangle, a triangle, a heart shape, or another irregular pattern) and a sliding vector (for example, a leftward, rightward, upward, downward, clockwise or counterclockwise sliding vector), but does not include a start position and an end position of the sliding trajectory on a device screen.

In a third manner, the first verification information is generated by the playing device according to a collected touch operation of the user at a first location on a screen, and the second verification information is generated by the source device according to a touch operation of the user at a second location on a screen. In a specific implementation, the touch operation may be a tap operation, a long press operation, a slide operation, or the like.

In a fourth manner, the first verification information is generated by the playing device according to a collected fingerprint image, and the second verification information is generated by the source device according to a collected fingerprint image.

Step 602: The playing device determines, according to the first verification information and the second verification information, that the source device and the playing device are successfully paired, obtains content of the media resource according to the address information of the media resource, and plays the content.

Preferably, the playing device compares the second verification information with the first verification information, and if the playing device determines that each fingerprint local feature point in the second verification information has a corresponding fingerprint local feature point in the first verification information, the playing device determines that the source device and the playing device are successfully paired; or

if the playing device determines that a ratio of a quantity of fingerprint local feature points in the second verification information that have corresponding fingerprint local feature points in the first verification information to a total quantity of fingerprint local feature points in the second verification information exceeds a specified threshold, the playing device determines that the source device and the playing device are successfully paired.

Preferentially, the generating, by the playing device, the first verification information according to a fingerprint image input by the user specifically includes, but is not limited to, the following specific implementation manners.

In a first implementation manner, after collecting a fingerprint image input by the user, and performing direction field correction on the fingerprint image, the playing device extracts a fingerprint local feature point from all sub-areas or an appointed sub-area of the fingerprint image that is obtained after the correction, and generates the first verification information according to the extracted fingerprint local feature point.

In a second implementation manner, after collecting a fingerprint image input by the user, and performing direction field correction on the fingerprint image, the playing device extracts a fingerprint local feature point from at least one sub-area of the fingerprint image that is obtained after the correction, generates the first verification information according to the extracted fingerprint local feature point, and adds location information of the at least one sub-area to the pairing request message.

In a third implementation manner, the pairing notification message carries location information of a sub-area of a fingerprint image corresponding to the second verification information generated by the source device, and after collecting a fingerprint image input by the user, and performing direction field correction on the collected fingerprint image, the playing device extracts a fingerprint local feature point from a sub-area that is determined according to location information of the sub-area of the fingerprint image that is obtained after the correction, and generates the first verification information according to the extracted fingerprint local feature point.

Correspondingly, the generating, by the source device, the second verification information according to a fingerprint image input by the user includes, but is not limited to, the following specific implementation manners.

In a first implementation manner, corresponding to the first manner of generating the first verification information, after collecting a fingerprint image input by the user, and performing direction field correction on the fingerprint image, the source device extracts a fingerprint local feature point from an appointed sub-area of the fingerprint image that is obtained after the correction, and generates the second verification information according to all or some extracted fingerprint local feature points.

In a second implementation manner, corresponding to the second manner of generating the first verification information, the pairing request message carries location information of a sub-area of a fingerprint image corresponding to the first verification information generated by the playing device, and after collecting a fingerprint image input by the user, and performing direction field correction on the collected fingerprint image, the source device extracts a fingerprint local feature point from a sub-area that is determined according to location information of the sub-area of the fingerprint image that is obtained after the correction, and generates the second verification information according to all or some extracted fingerprint local feature points.

In a third implementation manner, corresponding to the third manner of generating the first verification information, after collecting a fingerprint image input by the user, and performing direction field correction on the fingerprint image, the source device extracts a fingerprint local feature point from at least one sub-area of the fingerprint image that is obtained after the correction, generates the second verification information according to all or some extracted fingerprint local feature points, and adds location information of the at least one sub-area to the pairing notification message.

In the second embodiment of the present invention, a playing device generates first verification information according to a user operation, a source device generates second verification information according to a user operation, the playing device compares the second verification information sent by the source device with the first verification information generated by the playing device, after determining that the source device matches the playing device, the playing device requests a to-be-shared media resource from the source device, and the source device sends a media resource selected by a user to the playing device for playing. The user needs to perform only one operation on the playing device and only one operation on the source device to complete a process of sharing the media resource, where the playing device and the source device share the media resource, thereby reducing a quantity of user operations in the media resource sharing process, and reducing difficulty in a media resource sharing operation.

In a third embodiment of the present invention, based on an inventive concept that is the same as that of the first embodiment, a source device is provided. For a specific implementation of the source device, refer to the description of the source device in the foregoing first method embodiment, and repeated parts are no longer described. As shown in FIG. 7, the source device mainly includes:

a first processing module 701, configured to: determine a media resource selected by a user, generate first verification information according to a user operation, and receive an identifier of a playing device and second verification information that are sent by the playing device, where the second verification information is generated by the playing device according to a user operation; and

a second processing module 702, configured to: determine that the source device and the playing device are successfully paired, and send, according to the identifier of the playing device, the media resource to the playing device for playing; or send address information of the media resource to the playing device according to the identifier of the playing device, so that the playing device obtains the media resource according to the address information of the media resource and plays the media resource.

Preferably, the first processing module 701 is specifically configured to:

after determining the media resource selected by the user and generating the first verification information according to the user operation, send a pairing request message to the playing device, where the pairing request message includes an identifier of the source device, and receive a pairing response message that is returned by the playing device according to the pairing request message, where the pairing response message carries the second verification information and the identifier of the playing device; or

after receiving a pairing notification message sent by the playing device, determine the media resource selected by the user, and generate the first verification information according to the user operation, where the pairing notification message includes the second verification information and the identifier of the playing device; or

after determining the media resource selected by the user and generating the first verification information according to the user operation, receive a pairing notification message sent by the playing device, where the pairing notification message includes the second verification information and the identifier of the playing device.

Preferably, the first processing module 701 is specifically configured to:

after sending the pairing request message to the playing device, receive, within specified duration, the pairing response message that is returned by the playing device according to the pairing request message; or

after receiving the pairing notification message sent by the playing device, determine, within specified duration, the media resource selected by the user, and generate the first verification information according to the user operation; or

after determining the media resource selected by the user and generating the first verification information according to the user operation, receive, within specified duration, the pairing notification message sent by the playing device.

Preferably, the first processing module 701 is further configured to:

after receiving the pairing notification message sent by the playing device, display a list of shared media resources; and/or

before generating the first verification information according to the user operation, determine the currently displayed list of shared media resources.

In a specific implementation, the first processing module 701 is specifically configured to:

generate the first verification information according to collected voice information input by the user; or

generate the first verification information according to a collected sliding trajectory on a screen; or

generate the first verification information according to a collected touch operation of the user at a first location on a screen; or

generate the first verification information according to a collected fingerprint image.

Preferably, the first processing module 701 is specifically configured to:

after collecting a fingerprint image input by the user, and performing direction field correction on the fingerprint image, extract a fingerprint local feature point from all sub-areas or an appointed sub-area of the fingerprint image that is obtained after the correction, and generate the first verification information according to the extracted fingerprint local feature point; or

after collecting a fingerprint image input by the user, and performing direction field correction on the fingerprint image, extract a fingerprint local feature point from at least one sub-area of the fingerprint image that is obtained after the correction, generate the first verification information according to the extracted fingerprint local feature point, and add location information of the at least one sub-area to the pairing request message; or

add location information of a sub-area of a fingerprint image corresponding to the second verification information generated by the playing device to the pairing notification message, and after collecting a fingerprint image input by the user, and performing direction field correction on the collected fingerprint image, extract a fingerprint local feature point from a sub-area that is determined according to location information of the sub-area of the fingerprint image that is obtained after the correction, and generate the first verification information according to the extracted fingerprint local feature point.

In a fourth embodiment of the present invention, based on an inventive concept that is the same as that of the first embodiment, a source device is provided. For a specific implementation of the source device, refer to the description of the source device in the foregoing first embodiment, and repeated parts are no longer described. As shown in FIG. 8, the source device mainly includes:

a transceiver 801, configured to receive an identifier of a playing device and second verification information that are sent by the playing device, where the second verification information is generated by the playing device according to a user operation; and

a processor 802, configured to: determine a media resource selected by a user, generate first verification information according to a user operation, determine, according to the first verification information and the second verification information, that the source device and the playing device are successfully paired, and instruct the transceiver 801 to send address information of the media resource to the playing device according to the identifier of the playing device, so that the playing device obtains the media resource according to the address information of the media resource and plays the media resource.

Preferably, after determining the media resource selected by the user and generating the first verification information according to the user operation, the processor 802 instructs the transceiver 801 to send a pairing request message to the playing device, where the pairing request message includes an identifier of the source device; and the transceiver 801 receives a pairing response message that is returned by the playing device according to the pairing request message, where the pairing response message carries the second verification information and the identifier of the playing device; or

after the transceiver 801 receives a pairing notification message sent by the playing device, the processor 802 determines the media resource selected by the user, and generates the first verification information according to the user operation, where the pairing notification message includes the second verification information and the identifier of the playing device; or

after determining the media resource selected by the user and generating the first verification information according to the user operation, the processor 802 instructs the transceiver 801 to receive a pairing notification message sent by the playing device, where the pairing notification message includes the second verification information and the identifier of the playing device.

Preferably, after sending the pairing request message to the playing device, the transceiver 801 receives, within specified duration, the pairing response message that is returned by the playing device according to the pairing request message; or

after receiving the pairing notification message sent by the playing device, the transceiver 801 determines, within specified duration, the media resource selected by the user, and generates the first verification information according to the user operation; or

after determining the media resource selected by the user and generating the first verification information according to the user operation, the transceiver 801 receives, within specified duration, the pairing notification message sent by the playing device.

Preferably, the source device further includes a display 803, and after the transceiver 801 receives the pairing notification message sent by the playing device, the processor 802 instructs the display 803 to display a list of shared media resources; and/or

before generating the first verification information according to the user operation, the processor 802 determines the currently displayed list of shared media resources on the display 803.

In a specific implementation, the processor 802 generates the first verification information according to collected voice information input by the user; or

the processor 802 generates the first verification information according to a collected sliding trajectory on a screen; or

the processor 802 generates the first verification information according to a collected touch operation of the user at a first location on a screen; or

the processor 802 generates the first verification information according to a collected fingerprint image.

Preferably, after collecting a fingerprint image input by the user, and performing direction field correction on the fingerprint image, the processor 802 extracts a fingerprint local feature point from all sub-areas or an appointed sub-area of the fingerprint image that is obtained after the correction, and generates the first verification information according to the extracted fingerprint local feature point; or

after collecting a fingerprint image input by the user, and performing direction field correction on the fingerprint image, the processor 802 extracts a fingerprint local feature point from at least one sub-area of the fingerprint image that is obtained after the correction, generates the first verification information according to the extracted fingerprint local feature point, and adds location information of the at least one sub-area to the pairing request message; or

the processor 802 adds location information of a sub-area of a fingerprint image corresponding to the second verification information generated by the playing device to the pairing notification message, and after collecting a fingerprint image input by the user, and performing direction field correction on the collected fingerprint image, extracts a fingerprint local feature point from a sub-area that is determined according to location information of the sub-area of the fingerprint image that is obtained after the correction, and generates the first verification information according to the extracted fingerprint local feature point.

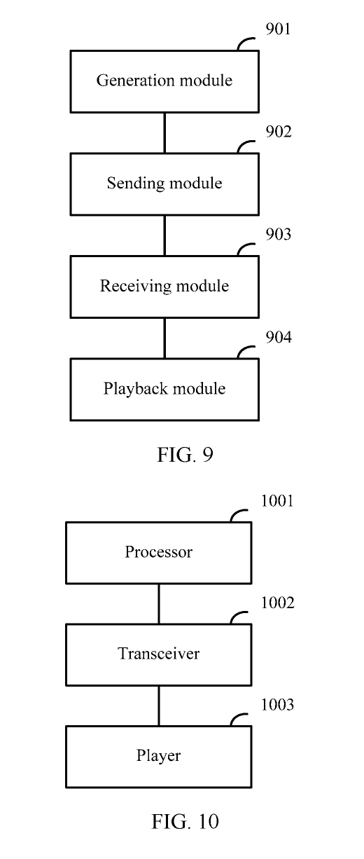

In a fifth embodiment of the present invention, based on an inventive concept that is the same as that of the first embodiment, a playing device is provided. For a specific implementation of the playing device, refer to the description of the playing device in the foregoing first embodiment, and repeated parts are no longer described. As shown in FIG. 9, the playing device mainly includes:

a generation module 901, configured to generate second verification information according to a user operation;

a sending module 902, configured to send the second verification information and an identifier of the playing device to a source device; and

a receiving module 903, configured to receive a media resource that is returned by the source device according to the identifier of the playing device; or receive address information of a media resource that is returned by the source device according to the identifier of the playing device, and obtain the media resource according to the address information of the media resource, where the media resource or the address information of the media resource is returned by the source device after the source device determines, according to the second verification information and first verification information that is generated by the source device according to a user operation, that the source device and the playing device are successfully paired; and

a playing module 904, configured to play the media resource.

Preferably, the receiving module 903 is further configured to receive a pairing request message sent by the source device, where the pairing request message is sent by the source device after the source device determines the media resource and generates the first verification information, and the pairing request message includes an identifier of the source device; and the sending module 902 is specifically configured to return a pairing response message to the source device according to the identifier of the source device, where the pairing response message carries the second verification information and the identifier of the playing device; or

the sending module 902 is specifically configured to send a pairing notification message, where the pairing notification message includes the second verification information and the identifier of the playing device.

Preferably, after the receiving module 903 receives the pairing request message, the sending module 902 sends a pairing response message within specified duration.

The generation module 901 is specifically configured to:

generate the second verification information according to collected voice information input by the user; or

generate the second verification information according to a collected sliding trajectory on a screen; or

generate the second verification information according to a touch operation of the user at a second location on a screen; or

generate the second verification information according to a collected fingerprint image.

Preferably, the generation module 901 is specifically configured to:

after collecting a fingerprint image input by the user, and performing direction field correction on the fingerprint image, extract a fingerprint local feature point from an appointed sub-area of the fingerprint image that is obtained after the correction, and generate the second verification information according to all or some extracted fingerprint local feature points; or

add location information of a sub-area of a fingerprint image corresponding to the first verification information generated by the source device to the pairing request message, and after collecting a fingerprint image input by the user, and performing direction field correction on the collected fingerprint image, extract a fingerprint local feature point from a sub-area that is determined according to location information of the sub-area of the fingerprint image that is obtained after the correction, and generate the second verification information according to all or some extracted fingerprint local feature points; or

after collecting a fingerprint image input by the user, and performing direction field correction on the fingerprint image, extract a fingerprint local feature point from at least one sub-area of the fingerprint image that is obtained after the correction, and generate the second verification information according to all or some extracted fingerprint local feature points; and the sending module 902 is further configured to add location information of the at least one sub-area to the pairing notification message.

In a sixth embodiment of the present invention, based on an inventive concept that is the same as that of the first embodiment, a playing device is provided. For a specific implementation of the playing device, refer to the description of the playing device in the foregoing first embodiment, and repeated parts are no longer described. As shown in FIG. 10, the playing device mainly includes:

a processor 1001, configured to generate second verification information according to a user operation;

a transceiver 1002, configured to: send the second verification information and an identifier of the playing device to a source device, and receive a media resource that is returned by the source device according to the identifier of the playing device; or receive address information of a media resource that is returned by the source device according to the identifier of the playing device, and obtain the media resource according to the address information of the media resource; and

a player 1003, configured to play the media resource.

The media resource or the address information of the media resource is returned by the source device after the source device determines, according to the second verification information and first verification information that is generated by the source device according to a user operation, that the source device and the playing device are successfully paired.

Preferably, the transceiver 1002 is further configured to: receive a pairing request message sent by the source device, where the pairing request message is sent by the source device after the source device determines the media resource and generates the first verification information, and the pairing request message includes an identifier of the source device; and return a pairing response message to the source device according to the identifier of the source device, where the pairing response message carries the second verification information and the identifier of the playing device; or

the transceiver 1002 is specifically configured to send a pairing notification message, where the pairing notification message includes the second verification information and the identifier of the playing device.

Preferably, after receiving the pairing request message, the transceiver 1002 sends a pairing response message within specified duration.

The processor 1001 generates the second verification information according to collected voice information input by the user; or

the processor 1001 generates the second verification information according to a collected sliding trajectory on a screen; or

the processor 1001 generates the second verification information according to a touch operation of the user at a second location on a screen; or

the processor 1001 generates the second verification information according to a collected fingerprint image.

Preferably, the processor 1001 is specifically configured to:

after collecting a fingerprint image input by the user, and performing direction field correction on the fingerprint image, extract a fingerprint local feature point from an appointed sub-area of the fingerprint image that is obtained after the correction, and generate the second verification information according to all or some extracted fingerprint local feature points; or

add location information of a sub-area of a fingerprint image corresponding to the first verification information generated by the source device to the pairing request message, and after collecting a fingerprint image input by the user, and performing direction field correction on the collected fingerprint image, extract a fingerprint local feature point from a sub-area that is determined according to location information of the sub-area of the fingerprint image that is obtained after the correction, and generate the second verification information according to all or some extracted fingerprint local feature points; or

after collecting a fingerprint image input by the user, and performing direction field correction on the fingerprint image, extract a fingerprint local feature point from at least one sub-area of the fingerprint image that is obtained after the correction, generate the second verification information according to all or some extracted fingerprint local feature points, and add location information of the at least one sub-area to the pairing notification message.

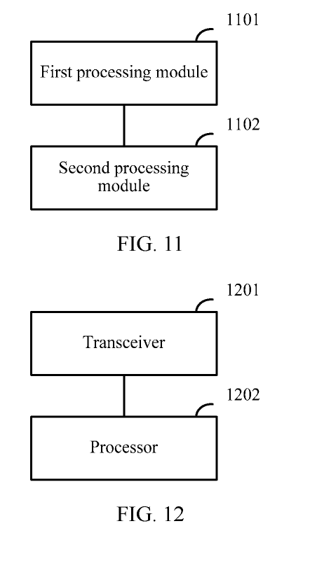

In a seventh embodiment of the present invention, based on an inventive concept that is the same as that of the second embodiment, a playing device is provided. For a specific implementation of the playing device, refer to the description of the playing device in the foregoing second embodiment, and repeated parts are no longer described. As shown in FIG. 11, the playing device mainly includes:

a first processing module 1101, configured to: generate first verification information according to a user operation, and receive address information of a media resource selected by a user and second verification information that are sent by a source device, where the second verification information is generated by the source device according to a user operation; and

a second processing module 1102, configured to: determine, according to the first verification information and the second verification information, that the source device and the playing device are successfully paired, obtain content of the media resource according to the address information of the media resource, and play the content.

Preferably, the first processing module 1101 is specifically configured to:

after generating the first verification information according to the user operation, send a pairing request message to the source device, where the pairing request message carries an identifier of the playing device, and receive a pairing response message that is returned by the source device according to the pairing request message, where the pairing response message carries the second verification information and the address information of the media resource; or

after receiving a pairing notification message sent by the source device, generate the first verification information according to the user operation, where the pairing notification message carries the second verification information and the address information of the media resource; or

after generating the first verification information according to the user operation, receive a pairing notification message sent by the source device, where the pairing notification message carries the second verification information and the address information of the media resource.

Preferably, the first processing module 1101 is specifically configured to:

after sending the pairing request message to the source device, receive, within specified duration, the pairing response message that is returned by the source device according to the pairing request message; or

after receiving the pairing notification message sent by the source device, generate the first verification information within specified duration according to the user operation; or

after generating the first verification information according to the user operation, receive, within specified duration, the pairing notification message sent by the source device.

Preferably, the first processing module 1101 is further configured to:

after receiving the pairing notification message, start a working mode of acquiring and playing a shared media resource; and/or

before generating the first verification information according to the user operation, determine that the playing device is in the working mode of acquiring and playing a shared media resource.

Specifically, the first processing module 1101 is specifically configured to:

generate the first verification information according to collected voice information input by the user; or

generate the first verification information according to a collected sliding trajectory on a screen; or

generate the first verification information according to a collected touch operation of the user at a first location on a screen; or

generate the first verification information according to a collected fingerprint image.

Preferably, the first processing module 1101 is specifically configured to:

after collecting a fingerprint image input by the user, and performing direction field correction on the fingerprint image, extract a fingerprint local feature point from all sub-areas or an appointed sub-area of the fingerprint image that is obtained after the correction, and generate the first verification information according to the extracted fingerprint local feature point; or

after collecting a fingerprint image input by the user, and performing direction field correction on the fingerprint image, extract a fingerprint local feature point from at least one sub-area of the fingerprint image that is obtained after the correction, generate the first verification information according to the extracted fingerprint local feature point, and add location information of the at least one sub-area to the pairing request message; or

add location information of a sub-area of a fingerprint image corresponding to the second verification information generated by the source device to the pairing notification message, and after collecting a fingerprint image input by the user, and performing direction field correction on the collected fingerprint image, extract a fingerprint local feature point from a sub-area that is determined according to location information of the sub-area of the fingerprint image that is obtained after the correction, and generate the first verification information according to the extracted fingerprint local feature point.

In an eighth embodiment of the present invention, based on an inventive concept that is the same as that of the second embodiment, a playing device is provided. For a specific implementation of the playing device, refer to the description of the playing device in the foregoing second embodiment, and repeated parts are no longer described. As shown in FIG. 12, the playing device mainly includes:

a transceiver 1201, configured to receive address information of a media resource selected by a user and second verification information that are sent by a source device, where the second verification information is generated by the source device according to a user operation; and

a processor 1202, configured to: generate first verification information according to a user operation, determine, according to the first verification information and the second verification information, that the source device and the playing device are successfully paired, instruct, according to the address information of the media resource, the transceiver 1201 to obtain content of the media resource, and play the content.

Preferably, after generating the first verification information according to the user operation, the processor 1202 instructs the transceiver 1201 to send a pairing request message to the source device, where the pairing request message carries an identifier of the playing device; and the transceiver 1201 receives a pairing response message that is returned by the source device according to the pairing request message, where the pairing response message carries the second verification information and the address information of the media resource; or

after the transceiver 1201 receives a pairing notification message sent by the source device, the processor 1202 generates the first verification information according to the user operation, where the pairing notification message carries the second verification information and the address information of the media resource; or

after generating the first verification information according to the user operation, the processor 1202 instructs the transceiver 1201 to receive a pairing notification message sent by the source device, where the pairing notification message carries the second verification information and the address information of the media resource.

Preferably, after sending the pairing request message to the source device, the transceiver 1201 receives, within specified duration, the pairing response message that is returned by the source device according to the pairing request message; or

after receiving the pairing notification message sent by the source device, the transceiver 1201 generates the first verification information within specified duration according to the user operation; or

after generating the first verification information according to the user operation, the processor 1202 instructs the transceiver 1201 to receive, within specified duration, the pairing notification message sent by the source device.

Preferably, after the transceiver 1201 receives the pairing notification message, the processor 1202 starts a working mode of acquiring and playing a shared media resource; and/or

before generating the first verification information according to the user operation, the processor 1202 determines that the playing device is in the working mode of acquiring and playing a shared media resource.

Specifically, the processor 1202 generates the first verification information according to collected voice information input by the user; or

the processor 1202 generates the first verification information according to a collected sliding trajectory on a screen; or

the processor 1202 generates the first verification information according to a collected touch operation of the user at a first location on a screen; or

the processor 1202 generates the first verification information according to a collected fingerprint image.

Preferably, after collecting a fingerprint image input by the user, and performing direction field correction on the fingerprint image, the processor 1202 extracts a fingerprint local feature point from all sub-areas or an appointed sub-area of the fingerprint image that is obtained after the correction, and generates the first verification information according to the extracted fingerprint local feature point; or

after collecting a fingerprint image input by the user, and performing direction field correction on the fingerprint image, the processor 1202 extracts a fingerprint local feature point from at least one sub-area of the fingerprint image that is obtained after the correction, generates the first verification information according to the extracted fingerprint local feature point, and adds location information of the at least one sub-area to the pairing request message; or

the processor 1202 adds location information of a sub-area of a fingerprint image corresponding to the second verification information generated by the source device to the pairing notification message, and after collecting a fingerprint image input by the user, and performing direction field correction on the collected fingerprint image, extracts a fingerprint local feature point from a sub-area that is determined according to location information of the sub-area of the fingerprint image that is obtained after the correction, and generates the first verification information according to the extracted fingerprint local feature point.

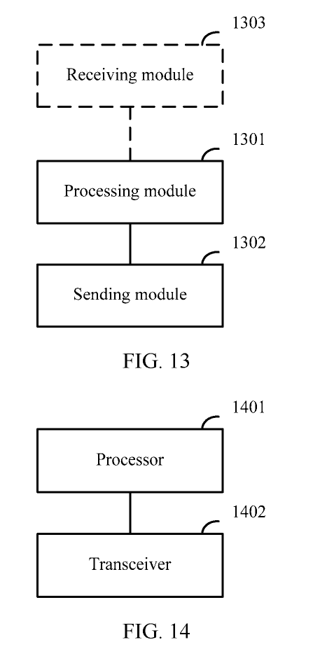

In a ninth embodiment of the present invention, based on an inventive concept that is the same as that of the second embodiment, a source device is provided. For a specific implementation of the source device, refer to the description of the source device in the foregoing second embodiment, and repeated parts are no longer described. As shown in FIG. 13, the source device mainly includes:

a processing module 1301, configured to: generate second verification information according to a user operation, and determine address information of a media resource selected by a user; and

a sending module 1302, configured to send the second verification information and the address information of the media resource to a playing device, so that after the playing device determines, according to the second verification information and first verification information that is generated by the playing device according to a user operation, that the playing device and the source device are successfully paired, the playing device obtains the media resource according to the address information of the media resource and plays the media resource.

Preferably, the source device further includes a receiving module 1303, configured to receive a pairing request message that is sent by the playing device after the playing device generates the first verification information, where the pairing request message carries an identifier of the playing device; and the sending module 1302 is specifically configured to return a pairing response message according to the pairing request message, where the pairing response message carries the second verification information and the address information of the media resource; or

the sending module 1302 is specifically configured to send a pairing notification message, where the pairing notification message carries the second verification information and the address information of the media resource.

Preferably, the processing module 1302 is specifically configured to:

generate the second verification information according to a collected sliding trajectory on a screen; or

generate the second verification information according to a touch operation of the user at a second location on a screen; or

generate the second verification information according to a collected fingerprint image.

Preferably, the processing module 1301 is specifically configured to:

after collecting a fingerprint image input by the user, and performing direction field correction on the fingerprint image, extract a fingerprint local feature point from an appointed sub-area of the fingerprint image that is obtained after the correction, and generate the second verification information according to all or some extracted fingerprint local feature points; or

add location information of a sub-area of a fingerprint image corresponding to the first verification information generated by the playing device to the pairing request message, and after collecting a fingerprint image input by the user, and performing direction field correction on the collected fingerprint image, extract a fingerprint local feature point from a sub-area that is determined according to location information of the sub-area of the fingerprint image that is obtained after the correction, and generate the second verification information according to all or some extracted fingerprint local feature points; or

after collecting a fingerprint image input by the user, and performing direction field correction on the fingerprint image, extract a fingerprint local feature point from at least one sub-area of the fingerprint image that is obtained after the correction, generate the second verification information according to all or some extracted fingerprint local feature points, and add location information of the at least one sub-area to the pairing notification message.

In a tenth embodiment of the present invention, based on an inventive concept that is the same as that of the second embodiment, a source device is provided. For a specific implementation of the source device, refer to the description of the source device in the foregoing second embodiment, and repeated parts are no longer described. As shown in FIG. 14, the source device mainly includes:

a processor 1401, configured to: generate second verification information according to a user operation, and determine address information of a media resource selected by a user; and

a transceiver 1402, configured to send the second verification information and the address information of the media resource to a playing device, so that after the playing device determines, according to the second verification information and first verification information that is generated by the playing device according to a user operation, that the playing device and the source device are successfully paired, the playing device obtains the media resource according to the address information of the media resource and plays the media resource.

Preferably, the transceiver 1402 receives a pairing request message that is sent by the playing device after the playing device generates the first verification information, where the pairing request message carries an identifier of the playing device; and returns a pairing response message according to the pairing request message, where the pairing response message carries the second verification information and the address information of the media resource; or

the transceiver 1402 sends a pairing notification message, where the pairing notification message carries the second verification information and the address information of the media resource.

Preferably, the processor 1401 is specifically configured to:

generate the second verification information according to a collected sliding trajectory on a screen; or

generate the second verification information according to a touch operation of the user at a second location on a screen; or

generate the second verification information according to a collected fingerprint image.

Preferably, the processor 1401 is specifically configured to:

after collecting a fingerprint image input by the user, and performing direction field correction on the fingerprint image, extract a fingerprint local feature point from an appointed sub-area of the fingerprint image that is obtained after the correction, and generate the second verification information according to all or some extracted fingerprint local feature points; or

add location information of a sub-area of a fingerprint image corresponding to the first verification information generated by the playing device to the pairing request message, and after collecting a fingerprint image input by the user, and performing direction field correction on the collected fingerprint image, extract a fingerprint local feature point from a sub-area that is determined according to location information of the sub-area of the fingerprint image that is obtained after the correction, and generate the second verification information according to all or some extracted fingerprint local feature points; or

after collecting a fingerprint image input by the user, and performing direction field correction on the fingerprint image, extract a fingerprint local feature point from at least one sub-area of the fingerprint image that is obtained after the correction, generate the second verification information according to all or some extracted fingerprint local feature points, and add location information of the at least one sub-area to the pairing notification message.

A person skilled in the art should understand that the embodiments of the present invention may be provided as a method, a system, or a computer program product. Therefore, the present invention may use a form of hardware only embodiments, software only embodiments, or embodiments with a combination of software and hardware. Moreover, the present invention may use a form of a computer program product that is implemented on one or more computer-usable storage media (including but not limited to a disk memory, an optical memory, and the like) that include computer-usable program code.

The present invention is described with reference to the flowcharts and/or block diagrams of the method, the device (system), and the computer program product according to the embodiments of the present invention. It should be understood that computer program instructions may be used to implement each process and/or each block in the flowcharts and/or the block diagrams and a combination of a process and/or a block in the flowcharts and/or the block diagrams. These computer program instructions may be provided for a general-purpose computer, a dedicated computer, an embedded processor, or a processor of any other programmable data processing device to generate a machine, so that the instructions executed by a computer or a processor of any other programmable data processing device generate an apparatus for implementing a specific function in one or more processes in the flowcharts and/or in one or more blocks in the block diagrams.

These computer program instructions may be stored in a computer readable memory that can instruct the computer or any other programmable data processing device to work in a specific manner, so that the instructions stored in the computer readable memory generate an artifact that includes an instruction apparatus. The instruction apparatus implements a specific function in one or more processes in the flowcharts and/or in one or more blocks in the block diagrams.

These computer program instructions may be loaded onto a computer or another programmable data processing device, so that a series of operations and steps are performed on the computer or the another programmable device, thereby generating computer-implemented processing. Therefore, the instructions executed on the computer or the another programmable device provide steps for implementing a specific function in one or more processes in the flowcharts and/or in one or more blocks in the block diagrams.

Obviously, a person skilled in the art can make various modifications and variations to the present invention without departing from the spirit and scope of the present invention. The present invention is intended to cover these modifications and variations provided that they fall within the scope of protection defined by the following claims and their equivalent technologies.

1.-40. (canceled)

41. A media resource sharing method, comprising:
determining, by a source device, a media resource selected by a user, generating first verification information according to a user operation, and receiving an identifier of a playing device and second verification information that are sent by the playing device; and
determining, by the source device according to the first verification information and the second verification information, that the source device and the playing device are successfully paired, and sending, according to the identifier of the playing device, one of:
the media resource to the playing device for playing; and
address information of the media resource, so that the playing device obtains the media resource according to the address information of the media resource and plays the media resource.

42. The method according to claim 1, wherein the determining, by a source device, a media resource selected by a user, generating first verification information according to a user operation, and receiving an identifier of a playing device and second verification information that are sent by the playing device comprises one of:
after the source device determines the media resource selected by the user and generates the first verification information according to the user operation, sending, by the source device, a pairing request message, comprising an identifier of the source device, to the playing device, and receiving a pairing response message that carries the second verification information and the identifier of the playing device and that is returned by the playing device according to the pairing request message;
after the source device receives a pairing notification message sent by the playing device, determining, by the source device, the media resource selected by the user, and generating the first verification information according to the user operation, wherein the pairing notification message comprises the second verification information and the identifier of the playing device; and
after the source device determines the media resource selected by the user and generates the first verification information according to the user operation, receiving, by the source device, a pairing notification message sent by the playing device, wherein the pairing notification message comprises the second verification information and the identifier of the playing device.

43. The method according to claim 2, further comprising one of:
after sending the pairing request message to the playing device, receiving, by the source device, within specified duration, the pairing response message that is returned by the playing device according to the pairing request message;
after receiving the pairing notification message sent by the playing device, determining, by the source device, within specified duration, the media resource selected by the user, and generating, by the source device, the first verification information according to the user operation; and
after determining the media resource selected by the user and generating the first verification information according to the user operation, receiving, by the source device, within specified duration, the pairing notification message sent by the playing device.

44. The method according to claim 2, wherein after the receiving, by the source device, a pairing notification message sent by the playing device, the method further comprises at least one of:
displaying, by the source device, a list of shared media resources; and
before the generating, by the source device, the first verification information according to the user operation, determining, by the source device, the currently displayed list of shared media resources.

45. The method according to claim 1, wherein the generating, by a source device, first verification information according to a user operation comprises one of:
generating, by the source device, the first verification information according to collected voice information input by the user;
generating, by the source device, the first verification information according to a collected sliding trajectory on a screen;
generating, by the source device, the first verification information according to a collected touch operation of the user at a first location on a screen; and
generating, by the source device, the first verification information according to a collected fingerprint image.

46. The method according to claim 2, wherein the generating, by a source device, first verification information according to a user operation comprises one of:
after the source device collects a fingerprint image input by the user, and performs direction field correction on the fingerprint image, extracting, by the source device, one of a fingerprint local feature point from all sub-areas and an appointed sub-area of the fingerprint image that is obtained after the correction, and generating the first verification information according to the extracted fingerprint local feature point;
after the source device collects a fingerprint image input by the user, and performs direction field correction on the fingerprint image, extracting, by the source device, a fingerprint local feature point from at least one sub-area of the fingerprint image that is obtained after the correction, generating the first verification information according to the extracted fingerprint local feature point, and adding location information of the at least one sub-area to the pairing request message; and
adding location information of a sub-area of a fingerprint image corresponding to the second verification information generated by the playing device to the pairing notification message, and after the source device collects a fingerprint image input by the user, and performs direction field correction on the collected fingerprint image, extracting, by the source device, a fingerprint local feature point from a sub-area that is determined according to location information of the sub-area of the fingerprint image that is obtained after the correction, and generating the first verification information according to the extracted fingerprint local feature point.

47. A media resource sharing method, comprising:
generating, by a playing device, second verification information according to a user operation;
sending, by the playing device, the second verification information and an identifier of the playing device to a source device; and one of:
receiving, by the playing device, a media resource that is returned by the source device according to the identifier of the playing device, and playing the media resource, a
receiving, by the playing device, address information of a media resource that is returned by the source device according to the identifier of the playing device, acquiring the media resource according to the address information of the media resource, and playing the media resource, wherein
the media resource or the address information of the media resource is returned by the source device after the source device determines, according to the second verification information and first verification information that is generated by the source device according to a user operation, that the source device and the playing device are successfully paired.

48. The method according to claim 7, wherein the sending, by the playing device, the second verification information and an identifier of the playing device to a source device comprises one of:
receiving, by the playing device, a pairing request message sent by the source device, wherein the pairing request message is sent by the source device after the source device determines the media resource and generates the first verification information, and the pairing request message comprises an identifier of the source device, and returning a pairing response message to the source device according to the identifier of the source device, wherein the pairing response message carries the second verification information and the identifier of the playing device; and
sending, by the playing device, a pairing notification message to the source device, wherein the pairing notification message comprises the second verification information and the identifier of the playing device.

49. The method according to claim 8, wherein the generating, by a playing device, second verification information according to a user operation comprises one of:
generating, by the playing device, the second verification information according to collected voice information input by the user;
generating, by the playing device, the second verification information according to a collected sliding trajectory on a screen;
generating, by the playing device, the second verification information according to a touch operation of the user at a second location on a screen; and
generating, by the playing device, the second verification information according to a collected fingerprint image.

50. The method according to claim 8, wherein the generating, by a playing device, second verification information according to a user operation comprises one of:
after the playing device collects a fingerprint image input by the user, and performs direction field correction on the fingerprint image, extracting, by the playing device, a fingerprint local feature point from an appointed sub-area of the fingerprint image that is obtained after the correction, and generating the second verification information according to all or some extracted fingerprint local feature points;
adding location information of a sub-area of a fingerprint image corresponding to the first verification information generated by the source device to the pairing request message, and after the playing device collects a fingerprint image input by the user, and performs direction field correction on the collected fingerprint image, extracting, by the playing device, a fingerprint local feature point from a sub-area that is determined according to location information of the sub-area of the fingerprint image that is obtained after the correction, and generating the second verification information according to all or some extracted fingerprint local feature points; and
after the playing device collects a fingerprint image input by the user, and performs direction field correction on the fingerprint image, extracting, by the playing device, a fingerprint local feature point from at least one sub-area of the fingerprint image that is obtained after the correction, generating the second verification information according to all or some extracted fingerprint local feature points, and adding location information of the at least one sub-area to the pairing notification message.

51. A source device, comprising a transceiver, a processor; and a non-transitory computer-readable storage medium including computer-executable instructions executed by the processor to perform operations comprising:
receiving, by the transceiver, an identifier of a playing device and second verification information that are sent by the playing device, wherein the second verification information is generated by the playing device according to a user operation;
determining a media resource selected by a user;
generating first verification information according to a user operation;
determining, according to the first verification information and the second verification information, that the source device and the playing device are successfully paired; and
instructing the transceiver to send address information of the media resource to the playing device according to the identifier of the playing device, so that the playing device obtains the media resource according to the address information of the media resource and plays the media resource.
